(19) United States
(12) Patent Application Publication
(10) Pub. No.: US 2025/0026697 A1
(43) Pub. Date: Jan. 23, 2025

(54) POLYMER FREE AND LOW ODOR UREASE INHIBITOR FORMULATION WITH IMPROVED STORAGE STABILITY ON UREA

(71) Applicant: BASF SE, Ludwigshafen (DE)

(72) Inventors: Maarten Staal, Limburgerhof (DE); Ulrike Malang, Limburgerhof (DE); Markus Schmid, Limburgerhof (DE); Gregor Pasda, Limburgerhof (DE); Uwe Thiel, Limburgerhof (DE); Manuel Knauer, Limburgerhof (DE); Birgit Blanz, Limburgerhof (DE)

(21) Appl. No.: 18/703,758

(22) PCT Filed: Oct. 24, 2022
(86) PCT No.: PCT/EP2022/079514

§ 371 Date: Apr. 23, 2024

(30) Foreign Application Priority Data
Oct. 26, 2021 (EP) 21204749.2

(51) Int. Cl. C05G 3/90; C05C 9/00; C05G 5/20; C05G 5/30

(52) U.S. Cl. CPC C05G 3/90; C05C 9/005; C05G 5/20; C05G 5/30

(57) ABSTRACT

The present invention relates to the use of a solvent selected from the group consisting of glycol ether, glycerin ether, and mixtures thereof for stabilizing at least one (thio)phosphoric acid triamide in a fertilizer composition (1) comprising a urea-containing fertilizer (F1) and a urease inhibitor formulation (Ul) comprising a mixture (A) comprising the at least one (thio)phosphoric acid triamide and the solvent (C), wherein the inhibitor formulation (Ul) is polymer free. Further, the present invention relates to a urease inhibitor formulation (Ul) and to a fertilizer composition (1) each comprising at least one (thio)phosphoric acid triamide and specific solvents.

The present invention relates to the use of a solvent (C) selected from the group consisting of glycol ether, glycerin ether, and mixtures thereof for stabilizing at least one (thio)phosphoric acid triamide in a fertilizer composition (1) comprising a urea-containing fertilizer (F1) and a urease inhibitor formulation (UI) comprising a mixture (A) comprising the at least one (thio)phosphoric acid triamide and the solvent (C), wherein the inhibitor formulation (UI) is polymer free. Further, the present invention relates to a specific urease inhibitor formulation (UI) and to a specific fertilizer composition (1) each comprising at least one (thio)phosphoric acid triamide and specific solvents.

Worldwide, the predominant and further-increasing amount of the nitrogen used for fertilizing is employed in the form of urea or urea-containing fertilizers. Urea itself, however, is a form of nitrogen which is absorbed very little if at all, being hydrolyzed relatively rapidly by the enzyme urease, which is present ubiquitously in the soil, to form ammonia and carbon dioxide. In this process, in certain circumstances, gaseous ammonia is emitted to the atmosphere, and is then no longer available in the soil for the plants, thereby lowering the efficiency of fertilization.

Ammonia volatilization can cause up to 80% loss of total nitrogen input from surface applied urea, depending on weather and soil conditions. Nitrogen losses result in yield reduction at farmer level and pose an environmental challenge. Ammonia volatilization can be reduced by using urease inhibitors. Next to emission reduction, urease inhibitors also improve the nitrogen-use-efficiency, increase yield performance and allow for a higher degree of freedom in fertilizer application strategy for the farmer. It is known that the degree of utilization of the nitrogen when using urea-containing fertilizers can be improved by spreading urea-containing fertilizers together with substances which are able to inhibit or decrease the enzymatic cleavage of urea (for a general review, see Kiss, S. Simihäian, M. (2002) Improving Efficiency of Urea Fertilizers by Inhibition of Soil Urease Activity, ISBN 1-4020-0493-1, Kluwer Academic Publishers, Dordrecht, The Netherlands). Among the most potent known urease inhibitors are N-alkylthiophosphoric acid triamides and N-alkylphosphoric acid triamides, which are described in EP 0119487, for example.

It is advisable to apply the urease inhibitors together with the urea onto or into the soil, since this ensures that the inhibitor comes into contact, together with the fertilizer, with the soil. The urease inhibitor may be incorporated in the urea by, for example, dissolving it into the melt prior to urea granulation or prilling. A process of this kind is described in U.S. Pat. No. 5,352,265, for example. A further option is to apply the urease inhibitor to the urea granules or prills, in the form of a solution, for example.

The shelf life of the urease inhibitor is limited. The higher the temperature, the shorter the storage life. If, for example, urea is stored under tropical conditions, a major part of the urease inhibitor has undergone decomposition, generally, after about four weeks of storage. If the urease inhibitor is introduced into the urea melt, the decomposition is less. For the commercialization of the urea stabilized with the urease inhibitor, however, it is often vital to apply the urease inhibitor to urea and to store the treated fertilizer until the time of its spreading to the soil.

N-(n-butyl)thiophosphoric acid triamide (NBPT) exemplarily is known to degrade when applied to urea (Soares et al, 17th International Nitrogen Workshop, 2012; Cantarella H, Soares JR, SousaRM, Otto R, SequeiraCH. Stability of urease inhibitor added to urea. Melbourne, Australia: 2016 International nitrogen initiative conference: solutions to improve nitrogen use efficiency for the world, 2016; Watson CJ, Akhonzada NA, Hamilton JTG, Matthews DI. Rate and mode of application of the urease inhibitor N-(n-butyl)thiophosphoric triamide on ammonia volatilization from surface-applied urea. Soil Use Management, 2008, 24:246-53). Attempts have been made to increase the shelf life of NBPT on urea. The stability of N-(n-butyl)thiophosphoric acid triamide (NBPT) and N-(n-propyl)thiophosphoric acid triamide (NPPT) on urea can e.g. be improved using stabilizers, as described in WO 2015/001457. There is however still the need of a stable urea-based granular fertilizer composition, which can be applied directly onto the field.

Since fertilizers are not only applied under tropical conditions, the urease inhibitor-containing formulation should further provide a sufficient cold stability, so that the urease inhibitor does not crystallize or freeze at lower temperature. Therefore, there is still a need for urease-inhibitor-containing formulations that are well balanced in cold stability and at higher temperatures.

Against this background it has been an object of the present invention to provide a stable, urea-containing fertilizer composition. In particular, it has been an object of the present invention to provide a stable urea-containing fertilizer composition, wherein not only the urea-containing fertilizer but also the urease inhibitor are stabilized, preferably even under tropical conditions for a sufficient time period. In this connection, a sufficient time period may be seen as e.g. one to three weeks, preferably about two weeks, when applied directly onto the field, since it is assumed that within this time period the nitrogen of urea-containing fertilizer is sufficiently absorbed into the soil due to at least the morning dew. With regards to storage, a sufficient time period may be seen as e.g. 6 to 24 months, preferably about 12 months. Further, it had been an object to provide a urease inhibitor-containing formulation having a sufficient cold stability.

In addition, it has been an object of this invention is to provide a urea-containing fertilizer composition that is free of micro plastics/polymers.

Further, it has been an object of the present invention to stabilize a urea-containing fertilizer composition comprising at least one (thio)phosphoric acid triamide.

Further, it has been an object of the present invention to provide a urease inhibitor formulation, which can easily be applied.

Finally, it has been an object of the present invention to provide a urease inhibitor-containing formulation, which is user-friendly (e.g. wherein the urease inhibitor-containing formulation has a reduced odor).

It has surprisingly been found by the inventors of the present invention, that at least one of the above objects can be achieved by the use of a solvent (C) as claimed. It has further been found by the inventors of the present invention, that the urease inhibitor formulation (UI) as claimed provides a sufficient cold and storage stability at elevated temperature.

In a first aspect, the present invention therefore relates to the use of a solvent (C) selected from the group consisting of glycol ether, glycerin ether, and mixtures thereof for stabilizing at least one (thio)phosphoric acid triamide in a fertilizer composition (1) comprising a urea-containing fertilizer (F1) and a urease inhibitor formulation (UI) comprising a mixture (A) comprising the at least one (thio)phosphoric acid triamide and the solvent (C), wherein the inhibitor formulation (UI) is polymer free.

In the following, preferred embodiments of the components of the use are described in further detail. It is to be understood that each preferred embodiment is relevant on its own as well as in combination with other preferred embodiments.

In a preferred embodiment A1 of the first aspect, the urease inhibitor formulation (UI) further comprises (B) a polar aprotic solvent, preferably a carboxylic acid amide, more preferably N,N-dimethyl lactamide preferably wherein the polar aprotic solvent improves the cold stability of the urease inhibitor formulation (UI).

In a preferred embodiment A2 of the first aspect, the urease inhibitor formulation (UI) is coated onto the urea-containing fertilizer (F1).

In a preferred embodiment A3 of the first aspect, the solvent (C) is selected from the group consisting of diethylene glycol, dipropylene glycol, triethylene glycol, di-ethyleneglycol monobutylether, triethyleneglycol-n-butylether, and mixtures thereof, in particular diethylene glycol and/or the solvent (C) has a flashpoint (determined according to ISO 2719:2016) of more than 130° C., preferably more than 135° C., and in particular more than 140° C.

In a preferred embodiment A4 of the first aspect, the mixture (A) comprises at least one (thio)phosphoric acid triamide according to general formula (I)

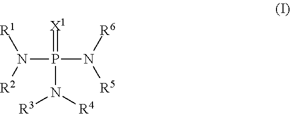

wherein
X¹ is O or S;
R¹ is C₁-C₂₀-alkyl, C₃-C₂₀-cycloalkyl, C₆-C₂₀-aryl, C₆-C₂₀-aryl-C₁-C₄-alkyl, or C₁-C₆-(di)alkylaminocarbonyl;
R² is H, C₁-C₂₀-alkyl, C₃-C₂₀-cycloalkyl, C₆-C₂₀-aryl, C₆-C₂₀-aryl-C₁-C₄-alkyl, or C₁-C₆-(di)alkylaminocarbonyl; or
R¹ and R² together with the nitrogen atom linking them define a 5- or 6-membered saturated or unsaturated heterocyclic radical, which optionally comprises 1 or 2 further heteroatoms selected from the group consisting of N, O, and S; and
R³, R⁴, R⁵, and R⁶ are independently of each other selected from the group consisting of H and C₁-C₄-alkyl; preferably
   wherein the mixture (A) comprises N-(n-butyl)thiophosphoric acid triamide (NBPT) and/or N-(n-propyl) thiophosphoric acid triamide (NPPT), in particular wherein the mixture (A) comprises N-(n-butyl) thiophosphoric acid triamide (NBPT) and N-(n-propyl)thiophosphoric acid triamide (NPPT) and/or
   wherein the at least one (thio)phosphoric acid triamide is comprised in the urease inhibitor formulation (UI) in an amount of 5 to less than 45 wt.-%, preferably of 10 to 42 wt.-%, and in particular of 15 to 40 wt.-%, based on the total amount of the urease inhibitor formulation (UI).

In a preferred embodiment A5 of the first aspect, the urease inhibitor formulation (UI) further comprises
(D) at least one amine selected from the group consisting of
(D2) an amine containing not more than one amino group and at least three alkoxy- or hydroxy-substituted C₂ to C₁₂ alkyl groups R²¹, wherein at least one of the groups R²¹ is different to the other groups R²¹,
(D3) an amine containing not more than one amino group and at least two alkoxy- or hydroxy-substituted C₂ to C₁₂ alkyl groups R²², wherein at least one of the groups R²² bears the alkoxy or hydroxy substituent at a secondary or tertiary carbon atom and wherein at least one of the groups R²² is different to the other group(s) R²²,
(D4) an amine containing at least one saturated or unsaturated C₈ to C₄₀ alkyl group R²³,
(D5) a saturated or unsaturated heterocyclic amine which contains at least one oxygen atom as ring atom and which does not contain a further alkoxy group, and
(D6) an amine selected from the group consisting of methyl-diethanolamine, methyl-diisopropanolamin, tetrahydroxy-propylethylenediamine, trimethylaminoethylethanolamine, N,N,N′,N′-tetramethyl-1,6-hexanediamine, N,N′,N″-tris(dimethylaminopropyl)hexahydrotriazine, and 2,2′-dimorpholinyldiethyl ether,
   preferably, wherein the at least one amine is selected from the group consisting of
(D2) an amine containing not more than one amino group and at least three hydroxy-substituted C₂ to C₈, preferably C₂ to C₅, more preferably C₂ to C₃ alkyl groups R²¹, wherein at least one of the groups R²¹ is different to the other groups R²¹,
(D3) an amine containing not more than one amino group and at least two alkoxy- or hydroxy-substituted C₂ to C₈, preferably C₂ to C₅, more preferably C₂ to C₃ alkyl groups R²², wherein at least one of the groups R²² bears the alkoxy or hydroxy substituent at a secondary or tertiary carbon atom and wherein at least one of the groups R²² is different to the other group(s) R²²,
(D6) an amine selected from the group consisting of methyl-diethanolamine, methyl-diisopropanolamin, and N,N′,N″-tris(dimethylaminopropyl)hexahydrotriazine,

in particular wherein the at least one amine is methyl-diethanolamine (MDEOA), methyl-diisopropanolamin (MDIPOA), methyl-ethanol-isopropanolamin (MEIPOA), N,N′,N″-tris(dimethylaminopropyl)hexahydrotriazine (NNN), 1,1′-((2-Hydroxyethyl)imino)dipropan-2-ol (EDIPOA) or bis(hydroxyethyl)-isopropanolamine (DEIPA).

In a preferred embodiment A6 of the first aspect, at least 85 wt.-%, preferably at least 90 wt.-%, more preferably at least 95 wt.-%, and in particular at least 97 wt.-%, of the at least one (thio)phosphoric acid triamide comprised in the urease inhibitor formulation (UI) are stable over a period of 14 days storage in closed bottles at 54° C.

In a preferred embodiment A7 of the first aspect, the pH of the urease inhibitor formulation (UI) is in the range of 8 to 10 and/or
the pH change delta of the urease inhibitor formulation (UI) after two weeks storage at 54° C. is less than ±0.8, preferably less than ±0.5, and in particular less than ±0.3 and/or
the urease inhibitor formulation (UI) has a viscosity at a shear rate of 100 s⁻¹ determined according to CIPAC method 192 (rotational rheometer) of at most 100 mPas, preferably at most 80 mPas at 20° C. and at most 170 mPas, preferably at most 150 mPas at 10° C.

In a second aspect, the present invention relates to a urease inhibitor formulation (UI) having a viscosity at a shear rate of 100s⁻¹ determined according to CIPAC method 192 (rotational rheometer) of at most 100 mPas, preferably at most 80 mPas, at 20° C. and at most 170 mPas, preferably at most 150 mPas, at 10° C. comprising
(A) 10 to 45 wt.-%, preferably 15 to 30 wt.-%, of a mixture (A) comprises N-(n-butyl)thiophosphoric acid triamide (NBPT) and N-(n-propyl)thiophosphoric acid triamide (NPPT),
(B) 0 to 50 wt.-%, preferably 8 to 22 wt.-%, of N,N-dimethyl lactamide,
(C) 20 to 85 wt.-%, preferably 40 to 70 wt.-%, of a solvent selected from the group consisting of glycol ether, glycerin ether, and mixtures thereof, and
(D) 3 to 25 wt.-%, preferably 4 to 15 wt.-%, of at least one amine selected from the group consisting of
(D2) an amine containing not more than one amino group and at least three alkoxy- or hydroxy-substituted C₂ to C₁₂ alkyl groups R²¹, wherein at least one of the groups R²¹ is different to the other groups R²¹,
(D3) an amine containing not more than one amino group and at least two alkoxy- or hydroxy-substituted C₂ to C₁₂ alkyl groups R²², wherein at least one of the groups R²² bears the alkoxy or hydroxy substituent at a secondary or tertiary carbon atom and wherein at least one of the groups R²² is different to the other group(s) R²²,
(D4) an amine containing at least one saturated or unsaturated C₈ to C₄₀ alkyl group R²³,
(D5) a saturated or unsaturated heterocyclic amine which contains at least one oxygen atom as ring atom and which does not contain a further alkoxy group, and
(D6) an amine selected from the group consisting of methyl-diethanolamine, methyl-diisopropanolamin, tetrahydroxy-propylethylenediamine, trimethylaminoethylethanolamine, N,N,N′,N′-tetramethyl-1,6-hexanediamine, N,N′N″-tris(dimethylaminopropyl)hexahydrotriazine, and 2,2′-dimorpholinyldiethyl ether,

each based on the total amount of the urease inhibitor formulation (UI), wherein the inhibitor formulation (UI) is polymer free.

In a preferred embodiment B1 of the second aspect, the solvent is selected from the group consisting of diethylene glycol, dipropylene glycol, triethylene glycol, di-ethyleneglycol monobutylether, triethyleneglycol-n-butylether, and mixtures thereof, in particular diethylene glycol and/or
the solvent has a flashpoint (determined according to ISO 2719:2016) of more than 130° C., preferably more than 135° C., and in particular more than 140° C.

In a third aspect, the present invention relates to a fertilizer composition (1) comprising a urea-containing fertilizer (F1) and mixture (M) comprising
(A) a mixture (A) comprising at least one (thio)phosphoric acid triamide;
(B) N,N-dimethyl lactamide; and
(C) a solvent selected from the group consisting of glycol ether, glycerin ether, and mixtures thereof, wherein mixture (M) is polymer free.

In a preferred embodiment C1 of the third aspect, the mixture (A) comprises at least one (thio)phosphoric acid triamide according to general formula (I)

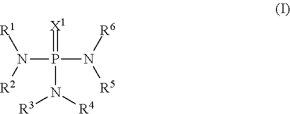

wherein
X¹ is O or S;
R¹ is C₁-C₂₀-alkyl, C₃-C₂₀-cycloalkyl, C₆-C₂₀-aryl, C₆-C₂₀-aryl-C₁-C₄-alkyl, or C₁-C₆-(di)alkylaminocarbonyl;
R² is H, C₁-C₂₀-alkyl, C₃-C₂₀-cycloalkyl, C₆-C₂₀-aryl, C₆-C₂₀-aryl-C₁-C₄-alkyl, or C₁-C₆-(di)alkylaminocarbonyl; or
R¹ and R² together with the nitrogen atom linking them define a 5- or 6-membered saturated or unsaturated heterocyclic radical, which optionally comprises 1 or 2 further heteroatoms selected from the group consisting of N, O, and S; and
R³, R⁴, R⁵, and R⁶ are independently of each other selected from the group consisting of H and C₁-C₄-alkyl; preferably

wherein the mixture (A) comprises N-(n-butyl)thiophosphoric acid triamide (NBPT) and/or N-(n-propyl)thiophosphoric acid triamide (NPPT), in particular wherein the mixture (A) comprises N-(n-butyl)thiophosphoric acid triamide (NBPT) and N-(n-propyl)thiophosphoric acid triamide (NPPT).

In a preferred embodiment C2 of the third aspect, the solvent is selected from the group consisting of diethylene glycol, dipropylene glycol, triethylene glycol, di-ethyleneglycol monobutylether, triethyleneglycol-n-butylether, and mixtures thereof, in particular diethylene glycol and/or the solvent has a flashpoint (determined according to ISO 2719:2016) of more than 130° C., preferably more than 135° C., and in particular more than 140° C.

In a preferred embodiment C3 of the third aspect, the mixture (M) further comprises
(D) at least one amine selected from the group consisting of
(D2) an amine containing not more than one amino group and at least three alkoxy- or hydroxy-substituted C₂ to C₁₂ alkyl groups R²¹, wherein at least one of the groups R²¹ is different to the other groups R²¹,
(D3) an amine containing not more than one amino group and at least two alkoxy- or hydroxy-substituted C₂ to C₁₂ alkyl groups R²², wherein at least one of the groups R²² bears the alkoxy or hydroxy substituent at a secondary or tertiary carbon atom and wherein at least one of the groups R²² is different to the other group(s) R²²,
(D4) an amine containing at least one saturated or unsaturated C₈ to C₄₀ alkyl group R²³,
(D5) a saturated or unsaturated heterocyclic amine which contains at least one oxygen atom as ring atom and which does not contain a further alkoxy group, and
(D6) an amine selected from the group consisting of methyl-diethanolamine, methyl-diisopropanolamin, tetrahydroxy-propylethylenediamine, trimethylaminoethylethanolamine, N,N,N′,N′-tetramethyl-1,6-hexanediamine, N,N′N″-tris(dimethylaminopropyl)hexahydrotriazine, and 2,2′-dimorpholinyldiethyl ether,
   preferably wherein the at least one amine is selected from the group consisting of
(D2) an amine containing not more than one amino group and at least three hydroxy-substituted C₂ to C₈, preferably C₂ to C₅, more preferably C₂ to C₃ alkyl groups R²¹, wherein at least one of the groups R²¹ is different to the other groups R²¹,
(D3) an amine containing not more than one amino group and at least two alkoxy- or hydroxy-substituted C₂ to C₈, preferably C₂ to C₅, more preferably C₂ to C₃ alkyl groups R²², wherein at least one of the groups R²² bears the alkoxy or hydroxy substituent at a secondary or tertiary carbon atom and wherein at least one of the groups R²² is different to the other group(s) R²²,
(D6) an amine selected from the group consisting of methyl-diethanolamine, methyl-diisopropanolamin, and N,N′,N″-tris(dimethylaminopropyl)hexahydrotriazine,

more preferably wherein the at least one amine is methyl-diethanolamine (MDEOA), methyl-diisopropanolamin (MDIPOA), methyl-ethanol-isopropanolamin (MEIPOA), N,N′,N″-tris(dimethylaminopropyl)hexahydrotriazine (NNN), 1,1′-((2-Hydroxyethyl)imino)dipropan-2-ol (EDIPOA) or bis(hydroxyethyl)-isopropanolamine (DEIPA), and in particular bis(hydroxyethyl)-isopropanolamine (DEIPA).

In a preferred embodiment C4 of the third aspect, the mixture (M) is coated onto the urea-containing fertilizer (F1).

In a preferred embodiment C5 of the third aspect, the urea-containing fertilizer (F1) comprises at least one component selected from the group consisting of urea, urea ammonium nitrate (UAN), isobutylidene diurea (IBDU), crotonylidene diurea (CDU) and urea formaldehyde (UF), urea-acetaldehyde, and urea-glyoxal condensates, preferably wherein the urea-containing fertilizer (F1) is urea.

### FIGURES

FIG. 1 depicts NxPT (NPPT and NBPT) recovery of formulations F1 to F4 after one month open storage at 40° C.

FIG. 2a depicts the cold stability of formulations comprising DEG+DML+DEIPA+NxPT or PG+DML+DEIPA+NxPT.

FIG. 2b depicts the cold stability of formulations comprising DEG+DML+PEI+NxPT or PG+DML+PEI+NxPT.

FIG. 3 depicts NxPT (referred to as A.i.) recovery of formulations F43, and F48 to F50 after two months open stage at 40° C. and 50% rh.

### DETAILED DESCRIPTION

Before describing in detail exemplary embodiments of the present invention, definitions important for understanding the present invention are given.

As used in this specification and in the appended claims, the singular forms of “a” and “an” also include the respective plurals unless the context clearly dictates otherwise. In the context of the present invention, the terms “about” and “approximately” denote an interval of accuracy that a person skilled in the art will understand to still ensure the technical effect of the feature in question. The term typically indicates a deviation from the indicated numerical value of ±20%, preferably ±15%, more preferably ±10%, and even more preferably ±5%. It is to be understood that the term “comprising” is not limiting. For the purposes of the present invention the term “consisting of” is considered to be a preferred embodiment of the term “comprising of”. If hereinafter a group is defined to comprise at least a certain number of embodiments, this is meant to also encompass a group which preferably consists of these embodiments only. Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(a)”, “(b)”, “(c)”, “(d)”, “i”, “ii” etc. relate to steps of a method or use or assay there is no time or time interval coherence between the steps, i.e. the steps may be carried out simultaneously or there may be time intervals of seconds, minutes, hours, days, weeks, months or even years between such steps, unless otherwise indicated in the application as set forth herein above or below. It is to be understood that this invention is not limited to the particular methodology, protocols, reagents etc. described herein as these may vary. It is also to be understood that the terminology used herein is for the purpose of describing particular embodiments only, and is not intended to limit the scope of the present invention that will be limited only by the appended claims. Unless defined otherwise, all technical and scientific terms used herein have the same meanings as commonly understood by one of ordinary skill in the art.

The term “wt.-%” as used throughout herein stands for “percent by weight”.

The terms “does not contain”, “does not comprise”, “free of”, and “being [ . . . ] free” as used herein are interchangeable and denote that the component referred to is not comprised in e.g. the respective composition/formulation.

The term “at least one” as used throughout herein above and below means one or more, preferably one or two, and thus typically refers individual compounds or mixtures/combinations.

As used herein, the term “(thio)phosphoric acid triamides” in each case covers thiophosphoric acid triamides and phosphoric acid triamides. Thus, the prefix “(thio)” as used herein in each case indicates that a group P═S or a group P═O is covered. It is noted that the terms “(thio)phosphoric acid triamide” and “(thio)phosphoric triamide” may interchangeably be used.

The organic moieties mentioned in the above definitions of the variables are collective terms for individual listings of the individual group members. The prefix Cₙ-Cₘ indicates in each case the possible number of carbon atoms in the group.

The term “alkyl” as used herein denotes in each case a straight-chain or branched alkyl group having usually from 1 to 20 carbon atoms, preferably from 1 to 10 carbon atoms, frequently from 1 to 6 carbon atoms, more preferably 1 to 4 carbon atoms, e.g. 3 or 4 carbon atoms. Examples of alkyl groups are methyl, ethyl, n-propyl, iso-propyl, n-butyl, 2-butyl, iso-butyl, tert-butyl, n-pentyl, 1-methylbutyl, 2-methylbutyl, 3-methylbutyl, 2,2-dimethylpropyl, 1-ethylpropyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, and 1-ethyl-2-methylpropyl. Preferred alkyl groups are methyl, ethyl, n-propyl, isopropyl, n-butyl, isobutyl, sec-butyl, tert-butyl, n-pentyl, isopentyl, neopentyl, tert-pentyl, hexyl, 2-methylpentyl, n-heptyl, n-octyl, 2-ethylhexyl, isooctyl, nonyl, isononyl, decyl, and isodecyl.

The term “cycloalkyl” as used herein denotes in each case a monocyclic cycloaliphatic radical having usually from 3 to 20 carbon atoms, preferably from 3 to 10 carbon atoms, more preferably from 3 to 6 carbon atoms, such as cyclopropyl, cyclobutyl, cyclopentyl, cyclohexyl, cycloheptyl, cyclooctyl, cyclononyl and cyclodecyl or cyclopropyl, cyclobutyl, cyclopentyl and cyclohexyl.

The term “aryl” includes mono-, bi- or tricyclic aromatic radicals having usually from 6 to 14, preferably 6, 10, or 14 carbon atoms. Exemplary aryl groups include phenyl, naphthyl and anthracenyl. Phenyl is preferred as aryl group.

The term “(di)alkylaminocarbonyl” refers to a (di)alkylamino group, i.e. an amino group comprising 1 or 2 alkyl substituents, which is bonded to the remainder of the molecule via the carbon atom of a carbonyl group (C═O).

The term “carboxylic acid amide” as used herein denotes in each case a the condensation product of a carboxylic acid and an amine.

The term “glycol ethers” as used herein refers to ethers comprising 1 to 4 glycol moieties. In certain embodiments, one or more carbon atom(s) of one or more glycol moiety/moieties may further be substituted by C₁-C₄-alkyl, preferably methyl. The glycol ether preferably has a molecular mass of less than 400 g/mol, more preferably less than 300 g/mol, and in particular less than 250 g/mol. In a preferred embodiment, the glycol ether has a molecular mass of 76 to 400 g/mol, preferably of 85 to 300 g/mol, more preferably of 90 to 250 g/mol, and in particular of 95 to 210 g/mol.

The term “glycerin ether” as used herein refers to ethers comprising 1 to 4 glycerin moieties. In certain embodiments, one or more carbon atom(s) of one or more glycerin moiety/moieties may further be substituted by C₁-C₄-alkyl, preferably methyl. The glycerin ether preferably has a molecular mass of less than 450 g/mol, more preferably less than 350 g/mol, and in particular less than 300 g/mol. In a preferred embodiment, the glycol ether has a molecular mass of 106 to 450 g/mol, preferably of 110 to 350 g/mol, more preferably of 120 to 300 g/mol, and in particular of 130 to 250 g/mol.

It is to be understood that, preferably, also stereoisomers, tautomers, N-oxides, and salts of the (thio)phosphoric acid triamide are covered by the term “(thio)phosphoric acid triamide”. Stereoisomers are present, if the compounds contain one or more centers of chirality. In this case, the compounds will be present in the form of different enantiomers or diastereomers, if more than one center of chirality is present. The term “(thio)phosphoric acid triamide” preferably covers every possible stereoisomer, i.e. single enantiomers or diastereomers, as well as mixtures thereof. Tautomers include, e.g., keto-enol tautomers. N-oxides may be formed under oxidative conditions, if tertiary amino groups are present. Salts may be formed, e.g., with the basic amino groups of the (thio)phosphoric acid triamide. Anions, which stem from an acid, with which the (thio)phosphoric acid triamide may have been reacted, are e.g. chloride, bromide, fluoride, hydrogensulfate, sulfate, dihydrogenphosphate, hydrogenphosphate, phosphate, nitrate, bicarbonate, carbonate, hexafluorosilicate, hexafluorophosphate, benzoate, and the anions of C₁-C₄-alkanoic acids, preferably formate, acetate, propionate and butyrate.

The (thio)phosphoric acid triamide according to the invention are preferably solid compounds with a melting point of at least 40° C., preferably at least 50° C., or with a melting point of at least 60° C., preferably at least 80° C., more preferably at least 85° C. Typically, the melting point is at most 200° C., preferably at most 185° C., more preferably at most 150° C., even more preferably at most 120° C., most preferably at most 100° C.

In connection with the melting points as provided herein above and below, it is to be understood that the defined melting points preferably refer to the melting points of the (thio)phosphoric acid triamide in pure form, i.e. not contaminated with impurities of more than 5 wt.-%, preferably not contaminated with impurities of more than 2 wt.-%, and not in the form of a mixture with another (thio)phosphoric acid triamide.

When referring to compositions and the weight percent of the therein comprised ingredients it is to be understood that according to the present invention the overall amount of ingredients does not exceed 100% (±1% due to rounding).

Preferred embodiments regarding the use of solvent (C), the urease inhibitor formulation (UI), and the fertilizer composition (1) are described in detail hereinafter. It is to be understood that the preferred embodiments of the invention are preferred alone or in combination with each other.

As indicated above, the present invention relates in one aspect to the use of a solvent (C) selected from the group consisting of glycol ether, glycerin ether, and mixtures thereof for stabilizing at least one (thio)phosphoric acid triamide in a fertilizer composition (1) comprising a urea-containing fertilizer (F1) and a urease inhibitor formulation (UI) comprising a mixture (A) comprising the at least one (thio)phosphoric acid triamide and the solvent (C), wherein the urease inhibitor formulation (UI) is polymer free.

Further disclosed is the use of a solvent (C) selected from the group consisting of glycol ether, glycerin ether, and mixtures thereof for stabilizing at least one (thio)phosphoric acid triamide in a fertilizer composition (1) comprising a urea-containing fertilizer (F1) and a urease inhibitor formulation (UI) comprising a mixture (A) comprising the at least one (thio)phosphoric acid triamide and the solvent (C).

The at least one (thio)phosphoric acid triamide (e.g. N-(n-butyl)thiophosphoric acid triamide (NBPT) and N-(n-propyl)thiophosphoric acid triamide (NPPT)) present in the fertilizer composition (1) according to the present invention preferably has a purity of more than 90%, more preferably more than 95%, and in particular more than 97% or of 90 to 100%, more preferably 95 to 99%, and in particular of 97 to 99%.

In a preferred embodiment, the urease inhibitor formulation (UI) further comprises
(B) a polar aprotic solvent. Preferably, the polar aprotic solvent is a carboxylic acid amide, more preferably N,N-dimethyl lactamide. Preferably, the polar aprotic solvent improves the cold stability of the urease inhibitor formulation (UI).

Within the meaning of the present invention, it is to be understood that the “cold stability” denotes the lowest temperature that does not lead to crystallization or freezing of the urease inhibitor formulation (UI) after one week closed storage and after one week closed storage after adding a seed crystal.

The urea-containing fertilizer (F1) can be in crystalline, granulated, compacted, prilled or ground form, and is preferably in granulated from.

The urease inhibitor formulation (UI) can be applied to or on the urea-containing fertilizer (F1) by either mixing the urease inhibitor formulation (UI) in either liquid or solid form, with the urea-containing fertilizer (F1), or incorporating them into the urea-containing fertilizer (F1) by granulation, compacting or prilling, by addition of corresponding fertilizer mixture or to a mash or melt. Preferably, the urease inhibitor formulation (UI) is applied to the surface of existing granules, compacts or prills of the urea-containing fertilizer (F1) by means of spraying, powder application or impregnating, for example. This can also be done using further auxiliaries such as adhesive promoters or encasing materials. Examples of apparatuses suitable for performing such application include plates, drums, mixers or fluidized-bed apparatus, although application may also take place on conveyor belts or their discharge points or by means of pneumatic conveyors for solids. A concluding treatment with anticaking agents and/or antidust agents is likewise possible. The urease inhibitor formulation (UI) is used in the context of fertilization with the urea-containing fertilizer (F1). Application takes place preferably to an agriculturally or horticulturally exploited plot.

In a preferred embodiment, the urease inhibitor formulation (UI) is coated onto the urea-containing fertilizer (F1). Coating may be achieved by any known in the art method.

In a preferred embodiment, the urease inhibitor formulation (UI) is sprayed onto the urea-containing fertilizer (F1), preferably using a rotating disc.

In a preferred embodiment, the urea-containing fertilizer (F1) comprises at least one component selected from the group consisting of urea, urea ammonium nitrate (UAN), isobutylidene diurea (IBDU), crotonylidene diurea (CDU) and urea formaldehyde (UF), urea-acetaldehyde, and urea-glyoxal condensates, preferably wherein the urea-containing fertilizer (F1) is urea.

In a preferred embodiment, the solvent (C) is a glycol ether, preferably selected from the group consisting of diethylene glycol, dipropylene glycol, triethylene glycol, di-ethyleneglycol monobutylether, triethyleneglycol-n-butylether, and mixtures thereof, more preferably selected from the group consisting of diethylene glycol, dipropylene glycol, and mixtures thereof, and in particular diethylene glycol.

In a preferred embodiment, the solvent (C) has a flashpoint (determined according to ISO 2719:2016) of more than 130° C., preferably more than 135° C., and in particular more than 140° C. The solvent (C) may have a flashpoint (determined according to ISO 2719:2016) of at most 400° C., or of at most 300° C.

In a preferred embodiment, the solvent (C) has a viscosity (determined at 20° C. according to Rotation viscometer; OECD test Guideline 114) of 2 to 60 mPas, preferably of 3 to 45 mPas, and in particular of 4 to 40 mPas.

In a preferred embodiment, the mixture (A) comprises at least one (thio)phosphoric acid triamide according to general formula (I)

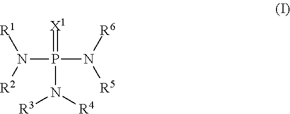

wherein
X¹ is O or S;
R¹ is C₁-C₂₀-alkyl, C₃-C₂₀-cycloalkyl, C₆-C₂₀-aryl, C₆-C₂₀-aryl-C₁-C₄-alkyl, or C₁-C₆-(di)alkylaminocarbonyl;
R² is H, C₁-C₂₀-alkyl, C₃-C₂₀-cycloalkyl, C₆-C₂₀-aryl, C₆-C₂₀-aryl-C₁-C₄-alkyl, or C₁-C₆-(di)alkylaminocarbonyl; or
R¹ and R² together with the nitrogen atom linking them define a 5- or 6-membered saturated or unsaturated heterocyclic radical, which optionally comprises 1 or 2 further heteroatoms selected from the group consisting of N, O, and S; and
R³, R⁴, R⁵, and R⁶ are independently of each other selected from the group consisting of H and C₁-C₄-alkyl.

In a preferred embodiment, the mixture (A) comprises at least two (thio)phosphoric acid triamides, preferably having the general formula (I) as above-outlined. In this connection, it is to be understood that the at least two (thio)phosphoric acid triamides are structurally different, e.g. have at least one different moiety according to general formula (I) as above-outlined.

In a preferred embodiment, the mixture (A) comprises at least N-(n-propyl)thiophosphoric acid triamide (NPPT).

In a preferred embodiment, the mixture (A) comprises at least N-(n-butyl)thiophosphoric acid triamide (NBPT).

In a preferred embodiment, the mixture (A) comprises N-(n-butyl)thiophosphoric acid triamide (NBPT) and/or N-(n-propyl)thiophosphoric acid triamide (NPPT), preferably N-(n-butyl)thiophosphoric acid triamide (NBPT) and N-(n-propyl)thiophosphoric acid triamide (NPPT).

In a preferred embodiment, the at least one (thio)phosphoric acid triamide is comprised in the urease inhibitor formulation (UI) in an amount of 5 to less than 45 wt.-%, preferably of 10 to 42 wt.-%, and in particular of 15 to 40 wt.-%, based on the total amount of the urease inhibitor formulation (UI). In a particular preferred embodiment, the at least one (thio)phosphoric acid triamide is comprised in the urease inhibitor formulation (UI) in an amount of 15 to 38 wt.-%, preferably of 18 to 35 wt.-%, and in particular of 20 to 30 wt.-%, based on the total amount of the urease inhibitor formulation (UI). Preferably, the urease inhibitor formulation (UI) comprises the sum of N-(n-butyl)thiophosphoric acid triamide (NBPT) and N-(n-propyl)thiophosphoric acid triamide (NPPT) in an amount of 5 to less than 45 wt.-%, preferably of 10 to 42 wt.-%, more preferably 15 to 40 wt.-%, even more preferably 15 to 38 wt.-%, still more preferably of 18 to 35 wt.-%, and in particular of 20 to 30 wt.-%, based on the total amount of the urease inhibitor formulation (UI).

In a preferred embodiment, the urease inhibitor formulation (UI) further comprises
(D) at least one amine selected from the group consisting of
(D2) an amine containing not more than one amino group and at least three alkoxy- or hydroxy-substituted C₂ to C₁₂ alkyl groups R²¹, wherein at least one of the groups R²¹ is different to the other groups R²¹,
(D3) an amine containing not more than one amino group and at least two alkoxy- or hydroxy-substituted C₂ to C₁₂ alkyl groups R²², wherein at least one of the groups R²² bears the alkoxy or hydroxy substituent at a secondary or tertiary carbon atom and wherein at least one of the groups R²² is different to the other group(s) R²²,
(D4) an amine containing at least one saturated or unsaturated C₈ to C₄₀ alkyl group R²³,
(D5) a saturated or unsaturated heterocyclic amine which contains at least one oxygen atom as ring atom and which does not contain a further alkoxy group, and
(D6) an amine selected from the group consisting of methyl-diethanolamine, methyl-diisopropanolamin, tetrahydroxy-propylethylenediamine, trimethylaminoethylethanolamine, N,N,N′,N′-tetramethyl-1,6-hexanediamine, N,N′,N″-tris(dimethylaminopropyl)hexahydrotriazine, and 2,2′-dimorpholinyldiethyl ether.

If present, the at least one amine is preferably selected from the group consisting of
(D2) an amine containing not more than one amino group and at least three hydroxy-substituted C₂ to C₈, preferably C₂ to C₅, more preferably C₂ to C₃ alkyl groups R²¹, wherein at least one of the groups R²¹ is different to the other groups R²¹,
(D3) an amine containing not more than one amino group and at least two alkoxy- or hydroxy-substituted C₂ to C₈, preferably C₂ to C₅, more preferably C₂ to C₃ alkyl groups R²², wherein at least one of the groups R²² bears the alkoxy or hydroxy substituent at a secondary or tertiary carbon atom and wherein at least one of the groups R²² is different to the other group(s) R²²,
(D6) an amine selected from the group consisting of methyl-diethanolamine, methyl-diisopropanolamin, and N,N′,N″-tris(dimethylaminopropyl)hexahydrotriazine.

Generally, the at least one amine (D) can be contained in varying amounts in the urease inhibitor formulation (UI). Preferably, the amount of (D) is not more than 80 wt.-%, more preferably not more than 60 wt.-%, most preferably not more than 40 wt.-%, most particularly preferably not more than 30 wt.-%, particularly not more than 15 wt.-%, for example not more than 10 wt.-%, based on the total weight of the urease inhibitor formulation (UI). Preferably, the amount of amine (D) is at least 1 wt.-%, more preferably at least 2 wt.-%, most preferably at least 3 wt.-%, most particularly preferably at least 4 wt.-%, particularly at least 5 wt.-%, for example at least 6 wt.-%, based on the total weight of the urease inhibitor formulation (UI).

Further disclosed is (D1) polymeric polyamine, which may be present in a non-polymer free urease inhibitor formulation (UI).

Generally, (D1) can be any polymeric polyamine, and is preferably a polyalkyleneimine or polyvinylamine, more preferably a polyalkyleneimine, most preferably a polyethyleneimine, polypropyleneimine, or polybutyleneimine, particularly a polyethyleneimine.

(D1) can be any polymeric polyamine comprising ethyleneimine (—CH2CH2NH—) as monomeric units, including homopolymers and any copolymers of ethyleneimine, and is preferably a homopolymer of ethyleneimine. Copolymers can be alternating, periodic, statistical or block copolymers.

Generally, (D1) can be of any polymer structure, for example a linear polymer, a ring polymer, a cross-linked polymer, a branched polymer, a star polymer, a comb polymer, a brush polymer, a dendronized polymer, or a dendrimer etc. (D1) can be an essentially linear polymer, and is preferably a linear polymer.

Polyethyleneimines which may be used are polyethyleneimine homopolymers which may be present in uncrosslinked or crosslinked form. The polyethyleneimine homopolymers can be prepared by known processes, as described, for example, in Römpps (Chemie Lexikon, 8th edition, 1992, pages 3532-3533), or in Ullmanns Enzyklopädie der Technischen Chemie, 4th edition, 1974, vol. 8, pages 212-213. and the literature stated there. They have a molecular weight in the range from about 200 to 1 000 000 g/mol. Corresponding commercial products are for example available under the name Lupasol® from BASF SE.

The polyethyleneimine (D1) can be a polyethylenimine having a degree of branching in the range of from 0.1 to 0.95 (also referred to as “highly branched polyethyleneimine”), and preferably a polyethylenimine having a degree of branching in the range of from 0.25 to 0.90, more preferably a polyethylenimine having a degree of branching in the range of from 0.30 to 0.80, and most preferably a polyethylenimine having a degree of branching in the range of 0.50 to 0.80.

Highly branched polyethyleneimines are characterized by its high degree of branching, which can be determined for example via ¹³C-NMR spectroscopy, preferably in D₂O, and is defined as follows:

Degree of branching=D+T/D+T+L

D (dendritic) equals the percentage of tertiary amino groups, L (linear) equals the percentage of secondary amino groups, and T (terminal) equals the percentage of primary amino groups.

Generally, the polymeric polyamine (D1) can have different weight average molecular weights. The weight average molecular weight of (D1) is preferably at least 200, more preferably at least 400, most preferably at least 550, particularly at least 650, for example at least 750. The weight average molecular weight of (D1) is preferably not more than 10,000, more preferably not more than 4,000, most preferably not more than 1,900, particularly not more than 1,500, for example not more than 1,350. The weight average molecular weight can be determined by standard gel permeation chromatography (GPC) known to the person skilled in the art.

In connection with polymeric amines, polyalkyleneimine or polyvinylamine, more preferably a polyalkyleneimine, most preferably a polyethyleneimine, polypropyleneimine, or polybutyleneimine shall be named.

According to another embodiment, (D) is (D2) an amine containing not more than one amino group and at least three alkoxy- or hydroxy-substituted C₂ to C₁₂ alkyl groups R²¹, wherein at least one of the groups R²¹ is different to the other groups R²¹.

A number of groups R²¹ within (D2) is at least 3, preferably 3 to 5, more preferably 3 to 4, and most preferably 3.

The number of carbon atoms in each group R²¹ within (D2) is 2 to 12, preferably 2 to 9, more preferably 2 to 7, most preferably 2 to 5, particularly preferably 2 to 4, particularly 2 to 3, for example 3, wherein said number of carbon atoms does not include carbon atoms in any alkoxy groups or any other substituents of R²¹.

The groups R²¹ within (D2) are alkoxy- or hydroxy-substituted, preferably hydroxy-substituted.

For one amine (D2), among the at least three groups R²¹, at least one of the groups R²¹ is different to the other groups R²¹, preferably one of the groups R²¹ is different to the other groups R²¹.

Preferably at least one of the groups R²¹, more preferably at least two of the groups R²¹, most preferably at least three of the groups R²¹, particularly all groups R²¹ is or are covalently bound to the amino group of the amine (D2).

According to another preferred embodiment, (D2)
is an amine containing not more than one amino group and at least three hydroxy-substituted C₂ to C₈- or preferably C₂ to C₅-alkyl groups R²¹, wherein at least one of the groups R²¹ is different to the other groups R²¹,
is preferably an amine containing not more than one amino group and at least three hydroxy-substituted C₂ to C₃ alkyl groups R²¹, wherein at least one of the groups R²¹ is different to the other groups R²¹,
is more preferably an amine containing not more than one amino group and three hydroxy-substituted C₂ to C₃ alkyl groups R²¹ which are covalently bound to the amino group, wherein one of the groups R²¹ is different to the other groups R²¹, and
is for example an amine selected from the group consisting of Bis(hydroxyethyl)-isopropanolamine (DEIPA), and 1,1′-((2-Hydroxyethyl)imino)dipropan-2-ol.

According to another preferred embodiment, (D2) is an amine N(R²¹)₃ wherein R²¹ is a an alkoxy- or hydroxy-substituted—preferably a hydroxyl-substituted—C₂ to C₁₂- preferably a C₂ to C₇, more preferably a C₂ to C₃-alkyl group and wherein one of the groups R²¹ is different to the other group R²¹.

According to another preferred embodiment, (D2) is an amine N (R²¹) 3 wherein R²¹ is a an alkoxy- or hydroxy-substituted—preferably a hydroxyl-substituted—C₂ to C₁₂- preferably a C₂ to C₇, more preferably a C₂ to C₃-alkyl group and wherein one of the groups R²¹ is different to the other group R²¹ and wherein at least one of the groups R²¹ bears the alkoxy or hydroxy substituent at a secondary or tertiary carbon atom.

According to another embodiment, (D) is (D3) an amine containing not more than one amino group and at least two alkoxy- or hydroxy-substituted C₂ to C₁₂ alkyl groups R²², wherein at least one of the groups R²² bears the alkoxy or hydroxy substituent at a secondary or tertiary carbon atom and wherein at least one of the groups R²² is different to the other group(s) R²².

A number of groups R²² within (D3) is at least 2, preferably 2 to 5, more preferably 2 to 4, and most preferably 2 to 3, for example 2.

The number of carbon atoms in each group R²² within (D3) is 2 to 12, preferably 2 to 9, more preferably 2 to 7, most preferably 2 to 5, particularly preferably 2 to 4, particularly 2 to 3, for example 3, wherein said number of carbon atoms does not include carbon atoms in any alkoxy groups or any other substituents of R²².

The groups R²² within (D3) are alkoxy- or hydroxy-substituted, preferably hydroxy-substituted.

For one amine (D3), among the at least two groups R²², at least one of the groups R²² is different to the other group(s) R²², preferably one of the groups R²² is different to the other group(s) R²².

Preferably at least one of the groups R²², more preferably at least two of the groups R²², most preferably all groups R²² is or are covalently bound to the amino group of the amine (D3).

Preferably at least one of the groups R²², more preferably one of the groups R²² bears the alkoxy or hydroxy substituent at a secondary or tertiary carbon atom, particularly at a secondary carbon atom.

According to another preferred embodiment, (D3)
is an amine containing not more than one amino group and at least two hydroxy-substituted C₂ to C₇ alkyl groups R²², wherein at least one of the groups R²² bears the hydroxy substituent at a secondary or tertiary carbon atom and wherein at least one of the groups R²² is different to the other group(s) R²²,
is more preferably an amine containing not more than one amino group and at least two hydroxy-substituted C₂ to C₄ alkyl groups R²², wherein at least one of the groups R²² bears the hydroxy substituent at a secondary carbon atom and wherein at least one of the groups R²² is different to the other group(s) R²²,
is most preferably an amine containing not more than one amino group and two hydroxy-substituted C₂ to C₃ alkyl groups R²² which are covalently bound to the amino group of the amine (D3), wherein at least one of the groups R²² bears the hydroxy substituent at a secondary carbon atom and wherein one of the groups R²² is different to the other group R²²,
is for example an amine selected from the group consisting of 1-((2-hydroxyethyl) amino)-propan-2-ol, and N-Methyl-N-hydroxyethyl-isopropanolamine.

According to another preferred embodiment, (D3) is an amine R²⁴N(R²²)² wherein R²⁴ is H or a C₁ to C₁₂—preferably a C₁ to C₇, more preferably a C₁ to C₃-alkyl group and R²² is an alkoxy-or hydroxy-substituted—preferably a hydroxyl-substituted—C₂ to C₁₂—preferably a C₂ to C₇, more preferably a C₂ to C₃-alkyl group and wherein at least one of the groups R²² bears the hydroxy substituent at a secondary carbon atom and wherein one of the groups R²² is different to the other group R²².

According to another embodiment, (D) is (D4) an amine containing at least one saturated or unsaturated C₈ to C₄₀ alkyl group R²³.

The number of carbon atoms in each group R²³ within (D4) is 8 to 40, preferably 8 to 32, more preferably 8 to 24, most preferably 8 to 19, particularly preferably 8 to 16.

The group R²³ within (D4) is saturated or unsaturated, preferably unsaturated.

According to another preferred embodiment, (D4) contains at least one alkoxy or hydroxy group, more preferably at least one alkoxy and at least one hydroxy groups, most preferably at least two alkoxy and at least one hydroxyl group, particularly at least four alkoxy and at least one hydroxyl group.

For example, (D4) is an amine selected from the group consisting of: ethoxylated (2) cocoalkylamine, ethoxylated (5) cocoalkylamine, ethoxylated (15) cocoalkylamine, ethoxylated (2) oleylamine, lauryl-dimethylamine, oleyl-dimethylamine, and 2-propylheptylamine ethoxylate (5 EO), 2-propylheptylamine ethoxylate (10 EO), and 2-propylheptylamine ethoxylate (20 EO).

According to another embodiment, (D) is (D5) a saturated or unsaturated heterocyclic amine which contains at least one oxygen atom as ring atom and which does not contain a further alkoxy group.

The term “heterocyclic amine” stands for a heterocyclic compound in which at least one ring atom of the heterocyclic ring is a nitrogen atom.

The heterocyclic amine (D5) is saturated or unsaturated, preferably saturated.

The heterocyclic amine (D5) contains preferably a 5-, 6- or 7-membered heterocyclic ring, more preferably a 5- or 6-membered ring, most preferably a 6-membered ring.

The heterocyclic amine (D5) contains at least one, more preferably 1 to 3, most preferably 1 to 2, particularly one oxygen atom(s) as ring atom(s) of the heterocyclic ring.

The heterocyclic amine (D5) is preferably a morpholine or morpholine derivative, more preferably N-alkyl morpholine, most preferably N-methyl, N-ethyl, N-propyl, or N-butyl morpholine, for example N-methyl morpholine.

The at least one amine is not a polymeric polyamine.

It is particularly preferred that, if present, the at least one amine (D) is (D2) an amine containing not more than one amino group and at least three hydroxy-substituted C₂ to C₈, preferably C₂ to C₅, more preferably C₂ to C₃ alkyl groups R²¹, wherein at least one of the groups R²¹ is different to the other groups R²¹, in particular wherein the amine is bis(hydroxyethyl)-isopropanolamine (DEIPA).

In a particular embodiment, the urease inhibitor formulation (UI) further comprises at least one amine selected from the group consisting of methyl-diethanolamine (MDEOA), methyl-diisopropanolamin (MDIPOA), methyl-ethanol-isopropanolamin (MEIPOA), N,N′,N″-tris(dimethylaminopropyl)hexahydrotriazine (NNN), 1,1′-((2-Hydroxyethyl)imino)dipropan-2-ol (EDIPOA), bis(hydroxyethyl)-isopropanolamine (DEIPA), and mixtures thereof.

The inhibitor formulation (UI) is polymer free. In a preferred embodiment, the fertilizer composition (1) is polymer free.

In a preferred embodiment, the weight ratio of the solvent (C) to the at least one (thio)phosphoric acid triamide is from 1:3 to 20:1, preferably from 1:2 to 10:1, more preferably from 1:1 to 5:1 and in particular from 2:1 to 3:1. In this connection it is to be understood that if more than one (thio)phosphoric acid triamide is present in the formulation, the weight ratio refers to the sum of all (thio)phosphoric acid triamides.

In a specific preferred embodiment, the weight ratio of the solvent (C) to the sum of N-(n-butyl)thiophosphoric acid triamide (NBPT) and N-(n-propyl)thiophosphoric acid triamide (NPPT) is from 1:3 to 20:1, preferably from 1:2 to 10:1, more preferably from 1:1 to 5:1 and in particular from 2:1 to 3:1.

In a preferred embodiment, the at least one (thio)phosphoric acid triamide is a mixture of N-(n-butyl)thiophosphoric acid triamide (NBPT) to N-(n-propyl)thiophosphoric acid triamide (NPPT), wherein the weight ratio of N-(n-butyl)thiophosphoric acid triamide (NBPT) to N-(n-propyl)thiophosphoric acid triamide (NPPT) is from 0.5:1 to 30:1, preferably from 1:1 to 20:1, more preferably from 1.5:1 to 20:1, even more preferably from 2:1 to 10:1, and in particular from 2.5:1 to 5:1.

In a preferred embodiment, the fertilizer composition (1) comprises the sum of N-(n-butyl)thiophosphoric acid triamide (NBPT) and N-(n-propyl)thiophosphoric acid triamide (NPPT) in an amount of 100 to 1000 ppm, preferably of 200 to 800 ppm, and in particular of 300 to 600 ppm.

If present, the weight ratio of the at least one amine (D) to the sum of N-(n-butyl)thiophosphoric acid triamide (NBPT) and N-(n-propyl)thiophosphoric acid triamide (NPPT) is preferably from 1:40 to 2:1, more preferably from 1:20 to 1:1, even more preferably from 1:10 to 1:2, and in particular from 1:6 to 1:3. In this connection it is to be understood that if more than one amine (D) is present in the formulation, the weight ratio refers to the sum of all amines (D).

The fertilizer composition (1) according to the present invention may further comprise components, such as a conditioning agent, an anti-caking agent, a pigment, a dye, formaldehyde, urea formaldehyde, and combinations thereof. In this connection, it is to be understood that urea formaldehyde is the reaction product of urea and formaldehyde (also known as UF).

Examples of a conditioning agent include, but are not limited to mineral oil and the like. In some embodiments, the conditioning agent is added to the fertilizer composition (1) after it is solidified into granules, prills, etc. In one embodiment, the conditioning agent is combined with the fertilizer composition (1) in a ratio of about 3:1 fertilizer composition (1) to conditioning agent.

Examples of an anti-caking agent include, but are not limited to lime, gypsum, silicon dioxide, kaolinite, or polyvinyl alcohol (PVA).

The pigments or dyes can be any available color are typically considered non-hazardous. In some embodiments, the dye is present in less than about 1 wt.-%, or less than about 2 wt.-%, or less than about 3 wt.-%, or of about 1 to 2 wt.-%, based on the total amount of the fertilizer composition (1).

In a preferred embodiment, the urease inhibitor formulation (UI) does not comprise dimethyl sulfoxide. Without being bound to any theory, it is assumed that formulations that do not comprise dimethyl sulfoxide have a reduced odor nuisance. Such formulations hence provide a sufficient fertilizer formulation having a reduced odor nuisance. In a further preferred embodiment, the urease inhibitor formulation (UI) does not comprise 1,2-propylene glycol.

In a preferred embodiment, at least 85 wt.-%, preferably at least 90 wt.-%, more preferably at least 95 wt.-%, and in particular at least 97 wt.-%, of the at least one (thio)phosphoric acid triamide comprised in the urease inhibitor formulation (UI) are stabile over a period of 14 days storage in closed bottles at 54° C. It is particularly preferred that at least 85 wt.-%, preferably at least 90 wt.-%, more preferably at least 95 wt.-%, and in particular at least 97 wt.-%, of the mixture (A) comprises N-(n-butyl)thiophosphoric acid triamide (NBPT) and N-(n-propyl)thiophosphoric acid triamide (NPPT) comprised in the urease inhibitor formulation (UI) are stabile over a period of 14 days storage in closed bottles at 54° C. Preferably, up to 99.5 wt.-% of the at least one (thio)phosphoric acid triamide is stable in the urease inhibitor formulation (UI) over a period of 14 days storage in closed bottles at 54° C.

In a preferred embodiment, the pH of the urease inhibitor formulation (UI) is in the range of 6 to 12, more preferably of 7 to 11, and in particular of 8 to 10.

In a preferred embodiment, the pH change delta of the urease inhibitor formulation (UI) after two weeks storage at 54° C. is less than ±0.8, preferably less than ±0.5, more preferably less than ±0.3, and in particular less than ±0.2. In this connection it is to be understood that the pH change delta is determined by determining the pH value of the freshly produced urease inhibitor formulation (UI) (providing “pH value F”) and of the urease inhibitor formulation (UI) after two weeks storage at 54° C. (providing “pH value S”). Preferably, the urease inhibitor formulation (UI) is stored in a closed container. The pH change delta is calculated via formula (I):

pH change delta=pH value F−pH value S (formula I)

In a preferred embodiment, the urease inhibitor formulation (UI) has a viscosity at a shear rate of 100 s⁻¹ determined according to CIPAC method 192 (rotational rheometer) of at most 100 mPas, preferably at most 90 mPas, more preferably at most 80 mPas, and in particular at most 75 mPas at 20° C. It is further preferred that the urease inhibitor formulation (UI) has a viscosity at a shear rate of 100 s⁻¹ determined according to CIPAC method 192 (rotational rheometer) of 1 to 100 mPas, preferably of 5 to 90 mPas, most preferably of 10 to 80 mPas, and in particular of 12 to 75 mPas at 20° C.

In a preferred embodiment, the urease inhibitor formulation (UI) has a viscosity at a shear rate of 100 s⁻¹ determined according to CIPAC method 192 (rotational rheometer) of at most 170 mPas, preferably at most 160 mPas, more preferably at most 150 mPas, and in particular at most 140 mPas at 10° C. It is further preferred that the urease inhibitor formulation (UI) has a viscosity at a shear rate of 100 s⁻¹ determined according to CIPAC method 192 (rotational rheometer) of 5 to 170 mPas, preferably of 10 to 160 mPas, more preferably of 15 to 150 mPas, and in particular of 20 to 140 mPas at 10° C.

In a preferred embodiment, the urease inhibitor formulation (UI) has a viscosity at a shear rate of 100 s⁻¹ determined according to CIPAC method 192 (rotational rheometer) of at most 100 mPas, preferably at most 90 mPas, more preferably at most 80 mPas, and in particular at most 75 mPas at 20° C. and of at most 170 mPas, preferably at most 160 mPas, more preferably at most 150 mPas, and in particular at most 140 mPas at 10° C.

In a preferred embodiment, the urease inhibitor formulation (UI) has a viscosity at a shear rate of 100 s⁻¹ determined according to CIPAC method 192 (rotational rheometer) of 1 to 90 mPas, preferably of 5 to 85 mPas, most preferably of 10 to 80 mPas, and in particular of 12 to 75 mPas at 20° C., after a period of 14 days storage in closed bottles at 54° C.

The urease inhibitor formulation (UI) according to the present invention preferably has a pH of 6 to 12, more preferably of 7 to 11, and in particular of 8 to 10.

The fertilizer composition (1) according to the present invention preferably has a pH of 7 to 12, more preferably of 8 to 11.

In one preferred embodiment, at least 40 wt.-%, preferably at least 45 wt.-%, more preferably at least 50 wt.-%, and in particular at least 55 wt.-%, of the at least one (thio)phosphoric acid triamide are stabile over a period of one month open storage at 40° C. at 50% relative humidity (rh).

In one preferred embodiment, at least 40 wt.-%, preferably at least 45 wt.-%, more preferably at least 50 wt.-%, and in particular at least 55 wt.-%, of the at least one (thio)phosphoric acid triamide are stabile over a period of two months open storage at 40° C. at 50% relative humidity (rh).

In one preferred embodiment, at least 40 wt.-%, preferably at least 45 wt.-%, more preferably at least 50 wt.-%, and in particular at least 55 wt.-%, of the sum of N-(n-butyl)thiophosphoric acid triamide (NBPT) and N-(n-propyl)thiophosphoric acid triamide (NPPT) are stabile over a period of one month open storage at 40° C. at 50% relative humidity (rh).

In one preferred embodiment, at least 40 wt.-%, preferably at least 45 wt.-%, more preferably at least 50 wt.-%, and in particular at least 55 wt.-%, of the sum of N-(n-butyl)thiophosphoric acid triamide (NBPT) and N-(n-propyl)thiophosphoric acid triamide (NPPT) are stabile over a period of two months open storage at 40° C. at 50% relative humidity (rh).

The above outlined stabilities may e.g. be determined by dissolving 2×15 g in 100 ml water and analyze the sample using HPLC method DIN_EN_16651 using the mean value.

In one preferred embodiment, the urease inhibitor formulation (UI) has a cold stability of −20 to −15° C., or of −15 to 15° C., or of −10 to 15° C., or of −5 to 15° C., or of 0 to 15° C., or of 5 to 15° C., or of 10 to 15° C. It is preferred that the urease inhibitor formulation (UI) has a cold stability of −20 to 0° C., or of −15 to 0° C., or of −10 to 0° C., or of −5 to 0° C. It is particularly preferred that the urease inhibitor formulation (UI) has a cold stability of −20 to −5° C., or of −15 to −5° C., or of −10 to −5° C.

As mentioned above, the invention further relates in a second aspect to a urease inhibitor formulation (UI) having a viscosity at a shear rate of 100 s⁻¹ determined according to CIPAC method 192 (rotational rheometer) of at most 100 mPas at 20° C. and at most 170 mPas at 10° C. comprising
(A) 10 to 45 wt.-% of a mixture (A) comprises N-(n-butyl)thiophosphoric acid triamide (NBPT) and N-(n-propyl)thiophosphoric acid triamide (NPPT),
(B) 0 to 50 wt.-% of a polar aprotic solvent, preferably a carboxylic acid amide, more preferably N,N-dimethyl lactamide,
(C) 20 to 85 wt.-% of a solvent selected from the group consisting of glycol ether, glycerin ether, and mixtures thereof, and
(D) 3 to 25 wt.-% of at least one amine selected from the group consisting of
(D2) an amine containing not more than one amino group and at least three alkoxy- or hydroxy-substituted C₂ to C₁₂ alkyl groups R²¹, wherein at least one of the groups R²¹ is different to the other groups R²¹,
(D3) an amine containing not more than one amino group and at least two alkoxy- or hydroxy-substituted C₂ to C₁₂ alkyl groups R²², wherein at least one of the groups R²² bears the alkoxy or hydroxy substituent at a secondary or tertiary carbon atom and wherein at least one of the groups R²² is different to the other group(s) R²²,
(D4) an amine containing at least one saturated or unsaturated C₈ to C₄₀ alkyl group R²³,
(D5) a saturated or unsaturated heterocyclic amine which contains at least one oxygen atom as ring atom and which does not contain a further alkoxy group, and
(D6) an amine selected from the group consisting of methyl-diethanolamine, methyl-diisopropanolamin, tetrahydroxy-propylethylenediamine, trimethylaminoethylethanolamine, N,N,N′,N′-tetramethyl-1,6-hexanediamine, N,N′N″-tris(dimethylaminopropyl)hexahydrotriazine, and 2,2′-dimorpholinyldiethyl ether,

each based on the total amount of the urease inhibitor formulation (UI), wherein the inhibitor formulation (UI) is polymer free.

Further disclosed is a urease inhibitor formulation (UI) having a viscosity at a shear rate of 100s⁻¹ determined according to CIPAC method 192 (rotational rheometer) of at most 100 mPas at 20° C. and at most 170 mPas at 10° C. comprising
(A) 10 to 45 wt.-% of a mixture (A) comprises N-(n-butyl)thiophosphoric acid triamide (NBPT) and N-(n-propyl)thiophosphoric acid triamide (NPPT),
(B) 0 to 50 wt.-% of a polar aprotic solvent, preferably a carboxylic acid amide, more preferably N,N-dimethyl lactamide,
(C) 20 to 85 wt.-% of a solvent selected from the group consisting of glycol ether, glycerin ether, and mixtures thereof, and
(D) 3 to 25 wt.-% of at least one amine selected from the group consisting of
(D1) a polymeric polyamine,
(D2) an amine containing not more than one amino group and at least three alkoxy- or hydroxy-substituted C₂ to C₁₂ alkyl groups R²¹, wherein at least one of the groups R²¹ is different to the other groups R²¹,
(D3) an amine containing not more than one amino group and at least two alkoxy- or hydroxy-substituted C₂ to C₁₂ alkyl groups R²², wherein at least one of the groups R²² bears the alkoxy or hydroxy substituent at a secondary or tertiary carbon atom and wherein at least one of the groups R²² is different to the other group(s) R²²,
(D4) an amine containing at least one saturated or unsaturated C₈ to C₄₀ alkyl group R²³,
(D5) a saturated or unsaturated heterocyclic amine which contains at least one oxygen atom as ring atom and which does not contain a further alkoxy group, and
(D6) an amine selected from the group consisting of methyl-diethanolamine, methyl-diisopropanolamin, tetrahydroxy-propylethylenediamine, trimethylaminoethylethanolamine, N,N,N′,N′-tetramethyl-1,6-hexanediamine, N,N′N″-tris(dimethylaminopropyl)hexahydrotriazine, and 2,2′-dimorpholinyldiethyl ether,

each based on the total amount of the urease inhibitor formulation (UI).

In this connection, the urease inhibitor formulation (UI) may comprises a polymeric amine such as polyalkyleneimine or polyvinylamine, preferably a polyalkyleneimine, more preferably a polyethyleneimine, polypropyleneimine, or polybutyleneimine.

It is particularly preferred that the polar aprotic solvent is N,N-dimethyl lactamide.

It is to be understood that all definitions and preferred embodiments as described above shall also hold for the specific urease inhibitor formulation (UI). Further preferred embodiments are described in detail herein after.

In a preferred embodiment, the urease inhibitor formulation (UI) has a viscosity at a shear rate of 100 s⁻¹ determined according to CIPAC method 192 (rotational rheometer) of at most 90 mPas, preferably at most 85 mPas, more preferably at most 80 mPas, even more preferably at most 75 mPas, and in particular at most 70 mPas, at 20° C. and at most 160 mPas, preferably at most 155 mPas, more preferably at most 150° C., even more preferably at most 140, and in particular at most 135 mPas, at 10° C. It is further preferred that the urease inhibitor formulation (UI) has a viscosity at a shear rate of 100 s⁻¹ determined according to CIPAC method 192 (rotational rheometer) of 1 to 90 mPas, preferably 3 to 85 mPas, more preferably 5 to 80 mPas, even more preferably 8 to 75 mPas, and in particular 10 to 70 mPas, at 20° C. and 5 to 160 mPas, preferably 8 to 155 mPas, more preferably 10 to 150° C., even more preferably 15 to 140, and in particular 20 to 135 mPas, at 10° C.

In a preferred embodiment, the urease inhibitor formulation (UI) has a viscosity at a shear rate of 100 s⁻¹ determined according to CIPAC method 192 (rotational rheometer) of 1 to 90 mPas, preferably of 5 to 85 mPas, most preferably of 10 to 80 mPas, and in particular of 12 to 75 mPas at 20° C., after a period of 14 days storage in closed bottles at 54° C.

In a preferred embodiment, the urease inhibitor formulation (UI) comprises
(A) 15 to 30 wt.-% of a mixture (A) comprises N-(n-butyl)thiophosphoric acid triamide (NBPT) and N-(n-propyl)thiophosphoric acid triamide (NPPT),
(B) 8 to 22 wt.-% of N,N-dimethyl lactamide,
(C) 40 to 70 wt.-% of a solvent selected from the group consisting of glycol ether, glycerin ether, and mixtures thereof, and
(D) 4 to 15 wt.-% of at least one amine selected from the group consisting of
(D2) an amine containing not more than one amino group and at least three alkoxy- or hydroxy-substituted C₂ to C₁₂ alkyl groups R²¹, wherein at least one of the groups R²¹ is different to the other groups R²¹,
(D3) an amine containing not more than one amino group and at least two alkoxy- or hydroxy-substituted C₂ to C₁₂ alkyl groups R²², wherein at least one of the groups R²² bears the alkoxy or hydroxy substituent at a secondary or tertiary carbon atom and wherein at least one of the groups R²² is different to the other group(s) R²²,
(D4) an amine containing at least one saturated or unsaturated C₈ to C₄₀ alkyl group R²³,
(D5) a saturated or unsaturated heterocyclic amine which contains at least one oxygen atom as ring atom and which does not contain a further alkoxy group, and
(D6) an amine selected from the group consisting of methyl-diethanolamine, methyl-diisopropanolamin, tetrahydroxy-propylethylenediamine, trimethylaminoethylethanolamine, N,N,N′,N′-tetramethyl-1,6-hexanediamine, N,N′N″-tris(dimethylaminopropyl)hexahydrotriazine, and 2,2′-dimorpholinyldiethyl ether,

each based on the total amount of the urease inhibitor formulation (UI).

In a particular preferred embodiment, the urease inhibitor formulation (UI) comprises
(A) 20 to 30 wt.-%, more preferably 22 to 28 wt.-%, of the sum of N-(n-butyl)thiophosphoric acid triamide (NBPT) and N-(n-propyl)thiophosphoric acid triamide (NPPT), based on the total amount of the urease inhibitor formulation (UI).

In a preferred embodiment, the solvent is a glycol ether, preferably selected from the group consisting of diethylene glycol, dipropylene glycol, triethylene glycol, di-ethyleneglycol monobutylether, triethyleneglycol-n-butylether, and mixtures thereof, more preferably selected from the group consisting of diethylene glycol, dipropylene glycol, and mixtures thereof, and in particular diethylene glycol.

In a preferred embodiment, the solvent has a flashpoint (determined according to ISO 2719:2016) of more than 130° C., preferably more than 135° C., and in particular more than 140° C.

In one preferred embodiment, the urease inhibitor formulation (UI) has a cold stability of −20 to 15° C., or of −15 to 15° C., or of −10 to 15° C., or of −5 to 15° C., or of 0 to 15° C., or of 5 to 15° C., or of 10 to 15° C. It is preferred that the urease inhibitor formulation (UI) has a cold stability of −20 to 0° C., or of −15 to 0° C., or of −10 to 0° C., or of −5 to 0° C. It is particularly preferred that the urease inhibitor formulation (UI) has a cold stability of −20 to −5° C., or of −15 to −5° C., or of −10 to −5° C.

In one preferred embodiment, at least 80 wt.-%, preferably at least 85 wt.-%, more preferably at least 90 wt.-%, even more preferably at least 95 wt.-%, and in particular at least 97 wt.-% of the N-(n-butyl)thiophosphoric acid triamide (NBPT) and N-(n-propyl)thiophosphoric acid triamide (NPPT) are stable in the urease inhibitor formulation (UI) over a period of 14 days storage in closed bottles at 54° C. Preferably, up to 99.5 wt.-% of the N-(n-butyl)thiophosphoric acid triamide (NBPT) and N-(n-propyl)thiophosphoric acid triamide (NPPT) are stable in the urease inhibitor formulation (UI) over a period of 14 days storage in closed bottles at 54° C.

In a preferred embodiment, the urease inhibitor formulation (UI) does not comprise dimethyl sulfoxide.

In a preferred embodiment, the urease inhibitor formulation (UI) does not comprise 1,2-propylene glycol.

The herewith disclosed urease inhibitor formulation (UI) is particularly suitable for applying to or on a urea-containing fertilizer (F1). Such a urea-containing fertilizer (F1) may be selected from the group consisting of urea, urea ammonium nitrate (UAN), isobutylidene diurea (IBDU), crotonylidene diurea (CDU) and urea formaldehyde (UF), urea-acetaldehyde, and urea-glyoxal condensates, preferably wherein the urea-containing fertilizer (F1) is urea.

As mentioned above, the invention further relates in a third aspect to a fertilizer composition (1) comprising a urea-containing fertilizer (F1) and mixture (M) comprising
(A) a mixture (A) comprising at least one (thio)phosphoric acid triamide;
(B) N,N-dimethyl lactamide; and
(C) a solvent selected from the group consisting of glycol ether, glycerin ether, and mixtures thereof, wherein the mixture (M) is polymer free.

In a preferred embodiment, the fertilizer composition (1) is polymer free.

Further disclosed is a fertilizer composition (1) comprising a urea-containing fertilizer (F1) and mixture (M) comprising
(A) a mixture (A) comprising at least one (thio)phosphoric acid triamide;
(B) N,N-dimethyl lactamide; and
(C) a solvent selected from the group consisting of glycol ether, glycerin ether, and mixtures thereof.

In this connection, mixture (M) may comprise a polymeric amine such as polyalkyleneimine or polyvinylamine, preferably a polyalkyleneimine, more preferably a polyethyleneimine, polypropyleneimine, or polybutyleneimine.

It is to be understood that all definitions and preferred embodiments as described above shall also hold for the specific fertilizer composition (1). Further preferred embodiments are described in detail herein after.

In a preferred embodiment, the mixture (A) comprises at least one (thio)phosphoric acid triamide according to general formula (I)

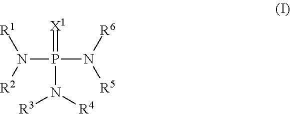

wherein
X¹ is O or S;
R¹ is C₁-C₂₀-alkyl, C₃-C₂₀-cycloalkyl, C₆-C₂₀-aryl, C₆-C₂₀-aryl-C₁-C₄-alkyl, or C₁-C₆-(di)alkylaminocarbonyl;
R² is H, C₁-C₂₀-alkyl, C₃-C₂₀-cycloalkyl, C₆-C₂₀-aryl, C₆-C₂₀-aryl-C₁-C₄-alkyl, or C₁-C₆-(di)alkylaminocarbonyl; or
R¹ and R² together with the nitrogen atom linking them define a 5- or 6-membered saturated or unsaturated heterocyclic radical, which optionally comprises 1 or 2 further heteroatoms selected from the group consisting of N, O, and S; and
R³, R⁴, R⁵, and R⁶ are independently of each other selected from the group consisting of H and C₁-C₄-alkyl.

In a preferred embodiment, the mixture (A) comprises at least two (thio)phosphoric acid triamides, preferably having the general formula (I) as above-outlined. In this connection, it is to be understood that the at least two (thio)phosphoric acid triamides are structurally different, e.g. have at least one different moiety according to general formula (I) as above-outlined.

In a preferred embodiment, the mixture (A) comprises at least N-(n-propyl)thiophosphoric acid triamide (NPPT).

In a preferred embodiment, the mixture (A) comprises at least N-(n-butyl)thiophosphoric acid triamide (NBPT).

In a preferred embodiment, the mixture (A) comprises N-(n-butyl)thiophosphoric acid triamide (NBPT) and/or N-(n-propyl)thiophosphoric acid triamide (NPPT), and in particular the mixture (A) comprises N-(n-butyl)thiophosphoric acid triamide (NBPT) and N-(n-propyl)thiophosphoric acid triamide (NPPT).

In a preferred embodiment, the solvent is a glycol ether, preferably selected from the group consisting of diethylene glycol, dipropylene glycol, triethylene glycol, di-ethyleneglycol monobutylether, triethyleneglycol-n-butylether, and mixtures thereof, more preferably selected from the group consisting of diethylene glycol, dipropylene glycol, and mixtures thereof, and in particular diethylene glycol.

In a preferred embodiment, the solvent has a flashpoint (determined according to ISO 2719:2016) of more than 130° C., preferably more than 135° C., and in particular more than 140° C.

In a preferred embodiment, the mixture (M) further comprises
(D) at least one amine selected from the group consisting of
(D2) an amine containing not more than one amino group and at least three alkoxy- or hydroxy-substituted C₂ to C₁₂ alkyl groups R²¹, wherein at least one of the groups R²¹ is different to the other groups R²¹,
(D3) an amine containing not more than one amino group and at least two alkoxy- or hydroxy-substituted C₂ to C₁₂ alkyl groups R²², wherein at least one of the groups R²² bears the alkoxy or hydroxy substituent at a secondary or tertiary carbon atom and wherein at least one of the groups R²² is different to the other group(s) R²²,
(D4) an amine containing at least one saturated or unsaturated C₈ to C₄₀ alkyl group R²³,
(D5) a saturated or unsaturated heterocyclic amine which contains at least one oxygen atom as ring atom and which does not contain a further alkoxy group, and
(D6) an amine selected from the group consisting of methyl-diethanolamine, methyl-diisopropanolamin, tetrahydroxy-propylethylenediamine, trimethylaminoethylethanolamine, N,N,N′,N′-tetramethyl-1,6-hexanediamine, N,N′N″-tris(dimethylaminopropyl)hexahydrotriazine, and 2,2′-dimorpholinyldiethyl ether,
   preferably wherein the at least one amine is selected from the group consisting of
(D2) an amine containing not more than one amino group and at least three hydroxy-substituted C₂ to C₈, preferably C₂ to C₅, more preferably C₂ to C₃ alkyl groups R²¹, wherein at least one of the groups R²¹ is different to the other groups R²¹,
(D3) an amine containing not more than one amino group and at least two alkoxy- or hydroxy-substituted C₂ to C₈, preferably C₂ to C₅, more preferably C₂ to C₃ alkyl groups R²², wherein at least one of the groups R²² bears the alkoxy or hydroxy substituent at a secondary or tertiary carbon atom and wherein at least one of the groups R²² is different to the other group(s) R²²,
(D6) an amine selected from the group consisting of methyl-diethanolamine, methyl-diisopropanolamin, and N,N′,N″-tris(dimethylaminopropyl)hexahydrotriazine,

more preferably wherein the at least one amine amine is methyl-diethanolamine (MDEOA), methyl-diisopropanolamin (MDIPOA), methyl-ethanol-isopropanolamin (MEIPOA), N,N′,N″-tris(dimethylaminopropyl)hexahydrotriazine (NNN), 1,1′-((2-Hydroxyethyl)imino)dipropan-2-ol (EDIPOA) or bis(hydroxyethyl)-isopropanolamine (DEIPA), and in particular bis(hydroxyethyl)-isopropanolamine (DEIPA).

In a preferred embodiment, the mixture (M) is coated onto the urea-containing fertilizer (F1).

In a preferred embodiment, the urea-containing fertilizer (F1) comprises at least one component selected from the group consisting of urea, urea ammonium nitrate (UAN), isobutylidene diurea (IBDU), crotonylidene diurea (CDU) and urea formaldehyde (UF), urea-acetaldehyde, and urea-glyoxal condensates, preferably wherein the urea-containing fertilizer (F1) is urea.

In one preferred embodiment, at least 40 wt.-%, preferably at least 45 wt.-%, more preferably at least 50 wt.-%, and in particular at least 55 wt.-%, of the at least one (thio)phosphoric acid triamide are stabile over a period of one month open storage at 40° C. at 50% relative humidity (rh).

In one preferred embodiment, at least 40 wt.-%, preferably at least 45 wt.-%, more preferably at least 50 wt.-%, and in particular at least 55 wt.-%, of the at least one (thio)phosphoric acid triamide are stabile over a period of two months open storage at 40° C. at 50% relative humidity (rh).

In one preferred embodiment, at least 40 wt.-%, preferably at least 45 wt.-%, more preferably at least 50 wt.-%, and in particular at least 55 wt.-%, of the sum of N-(n-butyl)thiophosphoric acid triamide (NBPT) and N-(n-propyl)thiophosphoric acid triamide (NPPT) are stabile over a period of one month open storage at 40° C. at 50% relative humidity (rh).

In one preferred embodiment, at least 40 wt.-%, preferably at least 45 wt.-%, more preferably at least 50 wt.-%, and in particular at least 55 wt.-%, of the sum of N-(n-butyl)thiophosphoric acid triamide (NBPT) and N-(n-propyl)thiophosphoric acid triamide (NPPT) are stabile over a period of two months open storage at 40° C. at 50% relative humidity (rh).

The above outlined stabilities may e.g. be determined by dissolving 2×15 g in 100 ml water and analyze the sample using HPLC method DIN_EN_16651 using the mean value.

The present invention is further illustrated by the following examples.

### EXAMPLES

Materials

| Material | Chemical name | CAS | Flashpoint (° C.) |
|---|---|---|---|
| Piagran 46 | Urea | | — |
| NBPT | n-butylthiophosphoric triamide | | — |
| NPPT | n-propylthiophosphoric triamide | | — |
| DEG | Diehtylene glycol | | 142 |
| DMSO | Dimehtyl sulfoxide | | 95 |
| PG | 1,2-Propylene glycol | | 99 |
| PEI | Polyethyleneimine, ca. 800 g/mol | 9002-98-6 | 180 |
| DEIPA | 1-[Bis-(2-hydroxyethyl)-amino]-2-propanol | 6712-98-7 | 191 |
| DML | N,N-Dimethyl lactamide | | 103 |
| NNN | N,N′,N″- | 15875-13-5 | — |
| | tris(dimethylaminopropyl)hexahydrotriazine | | |
| TEOA | Triethanolamine | 102-71-6 | — |
| TIPOA | Triisopropanolamine | 122-20-3 | — |
| MDEOA | Methyl-diethanolamin | 105-59-9 | — |
| MDIPOA | Methyl-diisopropanolamin | 4402-30-6 | — |
| EDIPOA | 1,1′-[(2-hydroxyethyl)imino]dipropan-2-ol | 10353-86-3 | — |
| MEIPOA | Methyl-ethanol-isopropanolamin | 16681-45-1 | — |

For the below examples and the below tables, the following abbreviations have been used:
%=percent by weight (wt. %)
B=polar, aprotic solvent
C=alcohol, polyol, polyether glycol solvent
D=amine
E=colorant
conc=concentration (e.g. amount) of NxPT in percent by weight based on the total weight of the urea fertilizer on which the composition was coated
visc i=initial viscosity in mPas
pH i=initial pH
delta pH=pH change after 2 weeks storage at 54° C.
Temp c=lowest temperature that does not lead to crystallization or freezing after 1 week storage+1 week storage after adding a seed crystal (° C.)
NxPT h=Content (Percent by weight) of NxPT after heat stability test (2 weeks at 54° C. in closed bottles)

### Preparation of the Formulations

According to the ratios and components as specified, all components were mixed, and the resulting mixture was stirred until complete dissolution of the solid and analyzed for the content of NBPT, NPPT, NxPT (by HPLC) and the viscosity. The formulations can be also prepared by mixing at first one or more different premixes of two or more components and combining them with the rest of the components. Mixing at elevated temperature (e.g. 40° C.) accelerates the dissolution.

Viscosity was measured according to CIPAC method 192 (rotational rheometer) with the undiluted formulation on a cone-plate rotational rheometer AR 2000ex (TA Instruments) at shear rate of 100 s⁻¹ at 20° C. or 10° C. (see indication on column header of examples).

### Formulation Storage Stability

The mixture of each example was stored in closed bottles for 14 days at 54° C. (referred to as heat stability test in the following) and then analyzed for the content of NxPT. The mixture of each example was also stored in closed bottles for 14 days at 5° C. and then analyzed for the content of NxPT. The storage stability in % was calculated as difference between the content in the heat stability test and the content in the 5° C. sample.

For the cold stability test, samples were kept at room temperature (20° C.), 10° C., 5° C., 0° C., −5° C., −10° C., −15° C. and −20° C. for one week. After addition of a seed crystal of NxPT, the samples were kept for one more week at the respective temperature. The coldest temperature that did not result in either crystallization or freezing was recorded.

All examples of the inventions are liquid, clear compositions with a yellow colourant. The same advantageous properties like enhanced cold stability, low odor and significantly improved storage stability of NxPT after coating on nitrogen containing fertilizer, apply to corresponding liquid compositions without colourant.

### Treatment of Urea Granules and Storage Stability on Urea

3 kg of urea granules were added to an ERWEKA mixer (dimensions mix drum: 50 cm diameter, 20 cm high). The mixer was turned on (27 RPM) and the amount of urease inhibitor formulation needed to reach an active ingredient concentration on urea of 0.054 wt % (0.0135 wt % NPPT+0.0405 wt % NBPT) was sprayed onto the urea using a syringe. Afterwards, the urea/inhibitor mixture was mixed for 3 minutes. The inhibitor treated urea granules were filled in 100 ml polyethylene bottles (50 g per bottle) and the bottles were stored open at 40° C. and 50% relative humidity. After 1 month storage time, samples were taken and analyzed for active ingredient concentration. From each sample 2×15 g was dissolved in 100 mL water and analyzed using HPLC method DIN_EN_16651. The resulting NxPT concentrations from both measurements were averaged. Recovery was calculated from initial value versus a measurement from storage stability samples.

### Example 1: NxPT Formulations in Different Solvents on Urea Granules

Formulations of NBPT and NPPT were prepared by mixing the following components:
F1: 6.25% NBPT, 18.25% NBPT, 74% DEG, 1% yellow colorant
F2: 6.25% NBPT, 18.25% NBPT, 74% PG, 1% yellow colorant

The following commercial urease inhibitor formulations were used:
F3: Agrotain Ultra: NBPT (15-40%), PG (40-70%), NMP (10-30%), non-hazardous dye (1-5%).
F4: Agrotain Advance: NBPT (15-40%), PG (30-60%), TIGMBE (15-40%) and DEGMBE (1-5%), non-hazardous ingredients (7-13%).

Urea granules were treated with the formulations as described in the methods section above. Analysis of stored samples was done after one month storage.

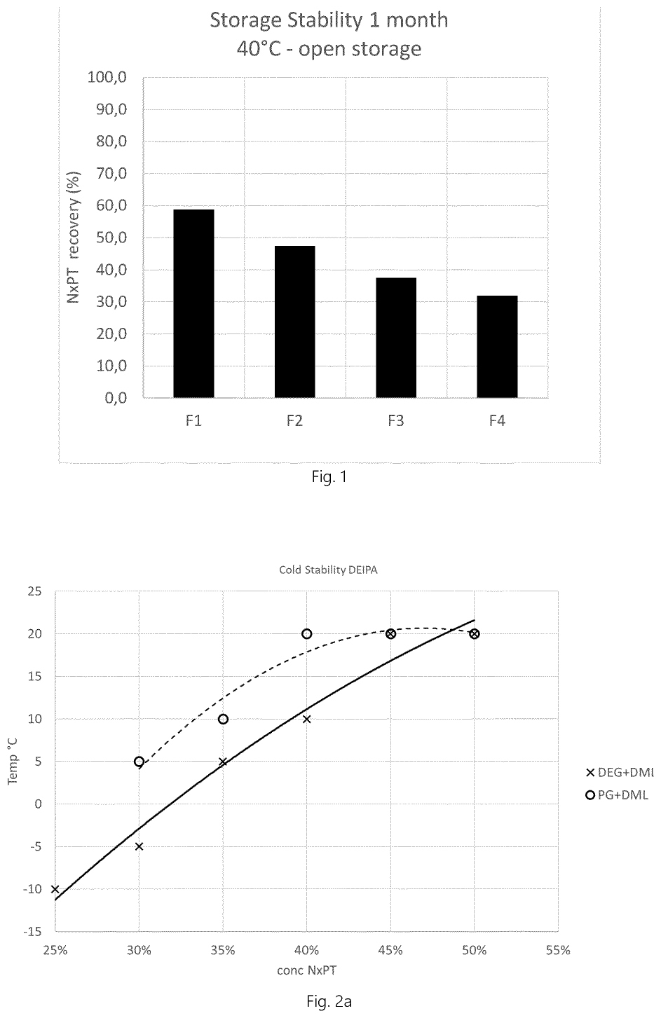

The results in FIG. 1 surprisingly show that the solvents used in the urease inhibitor formulations F1 to F4 have an influence on the stability of NxPT during storage of the treated urea. Among the tested glycols, diethylene glycol (DEG) proved to have the best stabilizing properties.

### Example 2: Solvent Mixtures for Excellent Cold Stability

Formulations of NBPT and NPPT were prepared according to recipes listed in Table 1. Samples of each formulation were characterized with viscosity, pH, heat stability and cold stability tests, according to the methods described above. The results of these tests are also documented in Table 1.

TABLE 1
formulation details and results of F5 to F25

| | NBPT | NPPT | conc | | conc | | conc | | conc | conc | visc i, | pH | NxPT | Temp |
|---|---|---|---|---|---|---|---|---|---|---|---|---|---|---|
| Form | pure | pure | NxPT | B | B | C | C | D | D | E | 20° C. | i | h | c |
| F5 | 37.50% | 12.50% | 50% | DML | 20.00% | DEG | 22.75% | PEI | 6.25% | 1.00% | 165 | 10.3 | 97.53% | 20 |
| F6 | 33.75% | 11.25% | 45% | DML | 20.00% | DEG | 27.75% | PEI | 6.25% | 1.00% | 147 | 10.3 | 98.76% | 20 |
| F7 | 30.00% | 10.00% | 40% | DML | 20.00% | DEG | 32.75% | PEI | 6.25% | 1.00% | 131 | 10.3 | 99.14% | 10 |
| F8 | 26.25% | 8.75% | 35% | DML | 20.00% | DEG | 37.75% | PEI | 6.25% | 1.00% | 119 | 10.3 | 99.71% | 5 |
| F9 | 18.75% | 6.25% | 25% | DML | 20.00% | DEG | 47.75% | PEI | 6.25% | 1.00% | 96 | 10.3 | 99.32% | −10 |
| F10 | 22.50% | 7.50% | 30% | DML | 20.00% | PG | 42.75% | PEI | 6.25% | 1.00% | 96 | 10.3 | 99.40% | 5 |
| F11 | 26.25% | 8.75% | 35% | DML | 20.00% | PG | 37.75% | PEI | 6.25% | 1.00% | 102 | 10.3 | 94.12% | 10 |
| F12 | 30.00% | 10.00% | 40% | DML | 20.00% | PG | 32.75% | PEI | 6.25% | 1.00% | 115 | 10.3 | 99.28% | 20 |
| F13 | 33.75% | 11.25% | 45% | DML | 20.00% | PG | 27.75% | PEI | 6.25% | 1.00% | 125 | 10.3 | 98.78% | 20 |
| F14 | 37.50% | 12.50% | 50% | DML | 20.00% | PG | 22.75% | PEI | 6.25% | 1.00% | 141 | 10.3 | 99.11% | 20 |
| F15 | 37.50% | 12.50% | 50% | DML | 20.00% | DEG | 22.75% | DEIPA | 6.25% | 1.00% | 104 | 9 | 97.13% | 20 |
| F16 | 33.75% | 11.25% | 45% | DML | 20.00% | DEG | 27.75% | DEIPA | 6.25% | 1.00% | 91 | 8.9 | 98.20% | 20 |
| F17 | 30.00% | 10.00% | 40% | DML | 20.00% | DEG | 32.75% | DEIPA | 6.25% | 1.00% | 82 | 8.9 | 98.02% | 10 |
| F18 | 26.25% | 8.75% | 35% | DML | 20.00% | DEG | 37.75% | DEIPA | 6.25% | 1.00% | 74 | 8.9 | 93.96% | 5 |
| F19 | 22.50% | 7.50% | 30% | DML | 20.00% | DEG | 42.75% | DEIPA | 6.25% | 1.00% | 69 | 9 | 97.47% | −5 |
| F20 | 18.75% | 6.25% | 25% | DML | 20.00% | DEG | 47.75% | DEIPA | 6.25% | 1.00% | 60 | 8.9 | 97.41% | −10 |
| F21 | 22.50% | 7.50% | 30% | DML | 20.00% | PG | 42.75% | DEIPA | 6.25% | 1.00% | 58 | 9 | 97.00% | 5 |
| F22 | 26.25% | 8.75% | 35% | DML | 20.00% | PG | 37.75% | DEIPA | 6.25% | 1.00% | 64 | 9 | 97.57% | 10 |
| F23 | 30.00% | 10.00% | 40% | DML | 20.00% | PG | 32.75% | DEIPA | 6.25% | 1.00% | 71 | 9 | 97.29% | 20 |
| F24 | 33.75% | 11.25% | 45% | DML | 20.00% | PG | 27.75% | DEIPA | 6.25% | 1.00% | 78 | 9 | 97.51% | 20 |
| F25 | 37.50% | 12.50% | 50% | DML | 20.00% | PG | 22.75% | DEIPA | 6.25% | 1.00% | 86 | 9 | 97.39% | 20 |

All recipes tested had a good performance concerning viscosity, pH, and active ingredient stability during the high temperature test. However, with respect to formulation performance in the cold temperature test, surprisingly DML+DEG was significantly better than DML+PG at a total active ingredient concentration NxPT of up to 40%.

Moreover, the cold temperature stability is plotted in different graphs (FIGS. 2a and 2b) for two amines exemplarily tested for a monomeric amine (DEIPA) and a polymeric amine (PEI), respectively. The graphs show a very similar pattern independent of the amine molecular weight. The influence of the chemistry of the amine stabilizer D has been further investigated in Example 3.

### Example 3: Formulation Performance Independent of Amine Chemistry

Formulations based on the solvent system DML+DEG with different alcohol-amines have been prepared according to the procedure given above according to the recipes displayed in Table 2. The respective results are given in Table 3.

TABLE 2
Formulation details of F9, F20, and F26 to F30

| | NBPT | NPPT | conc | | conc | | conc | | conc | conc |
|---|---|---|---|---|---|---|---|---|---|---|
| Form | pure | pure | NxPT | B | B | C | C | D | D | E |
| F20 | 18.75% | 6.25% | 25% | DML | 20.00% | DEG | 47.75% | DEIPA | 6.25% | 1.00% |
| F26 | 18.75% | 6.25% | 25% | DML | 20.00% | DEG | 47.75% | EDIPOA | 6.25% | 1.00% |
| F27 | 18.75% | 6.25% | 25% | DML | 20.00% | DEG | 47.75% | MDEOA | 6.25% | 1.00% |
| F28 | 18.75% | 6.25% | 25% | DML | 20.00% | DEG | 47.75% | MDIPOA | 6.25% | 1.00% |
| F29 | 18.75% | 6.25% | 25% | DML | 20.00% | DEG | 47.75% | MEIPOA | 6.25% | 1.00% |
| F30 | 18.75% | 6.25% | 25% | DML | 20.00% | DEG | 47.75% | NNN | 6.25% | 1.00% |
| F9 | 18.75% | 6.25% | 25% | DML | 20.00% | DEG | 47.75% | PEI | 6.25% | 1.00% |

TABLE 3
Results of F9, F20, and F26 to F30

| | | conc | visc i, | pH | NxPT | Temp |
|---|---|---|---|---|---|---|
| Form | D | D | 20° C. | i | h | c |
| F20 | DEIPA | 6.25% | 60 | 8.9 | 97.41% | −10 |
| F26 | EDIPOA | 6.25% | 62 | 9 | 97.48% | −10 |
| F27 | MDEOA | 6.25% | 54 | 9.6 | 96.48% | −10 |
| F28 | MDIPOA | 6.25% | 54 | 9.8 | 97.69% | −10 |
| F29 | MEIPOA | 6.25% | 52 | 9.7 | 98.05% | −15 |
| F30 | NNN | 6.25% | 70 | 11.2 | 94.08% | −10 |
| F9 | PEI | 6.25% | 96 | 10.3 | 99.32% | −10 |

The results of viscosity, pH, active ingredient stability and cold temperature test show that the resulting performance is independent of the detailed chemistry of the selected amines. They all perform equally well.

### Example 4: Solvent, Co-Solvent and Amine Combinations for Optimum Formulation Performance

Based on a design of experiment, a recipe optimization with respect to formulation performance has been carried out for the example system DML+DEG with DEIPA.

TABLE 4
Formulation details and results of F31 to F47, wherein B is DML, C
is DEG, and D is DEIPA and wherein 1.00% of colorant E is present.

| | NBPT | NPPT | conc | conc | conc | conc | | | | | NxPT | |
|---|---|---|---|---|---|---|---|---|---|---|---|---|
| | pure | pure | NxPT | B | C | D | visc i, | pH | visc i, | delta | h | Temp |
| Form | [%] | [%] | [%] | [%] | [%] | [%] | 20° C. | i | 10° C. | pH | [%] | c |
| F31 | 11.25 | 3.75 | 15 | 0.00 | 84.00 | 0.00 | 49 | 6.9 | 96 | 1.0 | 98.44 | −20 |
| F32 | 11.25 | 3.75 | 15 | 0.00 | 71.50 | 12.50 | 70 | 9.3 | 140 | 0.0 | 97.34 | −20 |
| F33 | 11.25 | 3.75 | 15 | 20.00 | 64.00 | 0.00 | 41 | 6.9 | 77 | 2.3 | 97.45 | −20 |
| F34 | 11.25 | 3.75 | 15 | 20.00 | 51.50 | 12.50 | 57 | 9 | 115 | 0.2 | 97.60 | −20 |
| F35 | 11.25 | 3.75 | 15 | 10.00 | 67.75 | 6.25 | 53 | 9 | 105 | 0.1 | 98.01 | −20 |
| F36 | 15.00 | 5.00 | 20 | 10.00 | 69.00 | 0.00 | 49 | 6.8 | 96 | 1.6 | 97.67 | −20 |
| F37 | 15.00 | 5.00 | 20 | 10.00 | 56.50 | 12.50 | 69 | 9.2 | 139 | 0.1 | 98.88 | −20 |
| F38 | 15.00 | 5.00 | 20 | 0.00 | 72.75 | 6.25 | 66 | 9 | 130 | 0.1 | 98.43 | −20 |
| F39 | 15.00 | 5.00 | 20 | 20.00 | 52.75 | 6.25 | 54 | 8.9 | 103 | 0.1 | 96.36 | −20 |
| F40 | 15.00 | 5.00 | 20 | 10.00 | 62.75 | 6.25 | 62 | 8.9 | 112 | 0.2 | 97.71 | −20 |
| F41 | 15.00 | 5.00 | 20 | 10.00 | 62.75 | 6.25 | 60 | 8.9 | 113 | 0.2 | 97.09 | −20 |
| F42 | 15.00 | 5.00 | 20 | 10.00 | 62.75 | 6.25 | 62 | 8.9 | 115 | 0.2 | 97.42 | −20 |
| F43 | 18.75 | 6.25 | 25 | 0.00 | 74.00 | 0.00 | 60 | 6.9 | 114 | 1.4 | 99.29 | −5 |
| F44 | 18.75 | 6.25 | 25 | 0.00 | 61.50 | 12.50 | 85 | 9.2 | 169 | 0.1 | 98.78 | 0 |
| F45 | 18.75 | 6.25 | 25 | 20.00 | 54.00 | 0.00 | 50 | 6.9 | 95 | 1.8 | 97.95 | −20 |
| F46 | 18.75 | 6.25 | 25 | 20.00 | 41.50 | 12.50 | 71 | 9.1 | 153 | 0.1 | 98.20 | −10 |
| F47 | 18.75 | 6.25 | 25 | 10.00 | 57.75 | 6.25 | 65 | 8.9 | 127 | 0.1 | 98.38 | −10 |

Recipes F31, F33, F36, F43 and F45 display a high delta pH during storage of 2W54° C., of more than 0.8. They do not contain any stabilizer D. On the other hand all stabilizer D containing formulation recipes lead to excellent delta pH below 0.3. Thus, the stabilizer D is an essential recipe component to achieve good pH stability. Formulations F32, F34, F35, F37, F38, F39, F40, F41 and F42 display a good active ingredient stability (NxPT h>95%) as well as a low delta pH. Furthermore, these recipes are low viscous (below 80 mPas at 20° C. and below 150 mPas at 10° C.) and show excellent cold stability of −20° C. However, F32 to F41 only have a concentration of maximally 15% NxPT. Recipe numbers F46 and F47 with 25% active ingredient content have a stable active ingredient content (>95%) and a pH change less than 0.3 after 2 weeks storage at 54° C. Furthermore, it displays a low viscosity of less than 80 mPas at 20° C. and show good cold stability of −10° C. F46 has a viscosity above 150 mPas at 10° C. while F47 viscosity still lies in the acceptable range below 150 mPas. Thus, a lower stabilizer D content and a higher solvent C content are of advantage.

### Example 5: Urea Granules Treated With Formulations of NxPT in DEG With Co-Solvent and Amine Stabilizer, Active Ingredient Stability on Granules

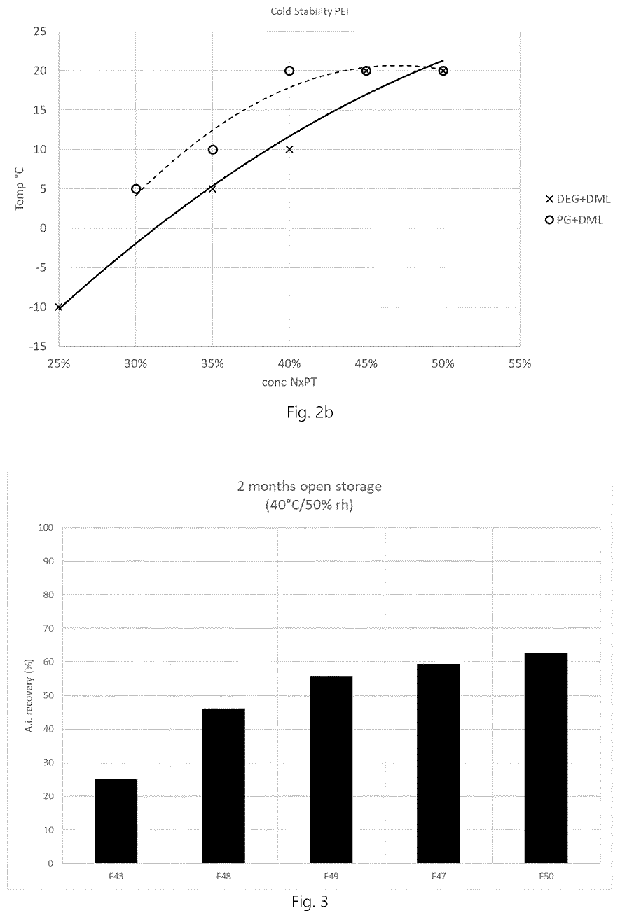

The formulations were manufactured in accordance with the above-outlined methods and Table 5. As can be seen from FIG. 3, the best recovery of NxPT can be obtained when the formulation comprises DEG, DEIPA, and DML (Agnique AMD 3 L).

TABLE 5
Formulation details of F5 to F9

| | Formulation composition (wt %) | | | | | | | | |
|---|---|---|---|---|---|---|---|---|---|
| | | | | | | | Agnique | | |
| Form | NPPT | NBPT | PG | DMSO | PEI | DEIPA | AMD 3 L | Colorant | DEG |
| F43 | 6.25 | 18.75 | | | | | | 1 | 74 |
| F48 | 6.25 | 18.75 | 47.75 | 20 | 6.25 | | | 1 | |
| F49 | 6.25 | 18.75 | | | | 4 | 10 | 1 | 60 |
| F47 | 6.25 | 18.75 | | | | 6.25 | 10 | 1 | 57.75 |
| F50 | 6.25 | 18.75 | | | | 8 | 10 | 1 | 56 |

1. A method for stabilizing at least one (thio)phosphoric acid triamide in a fertilizer composition (1) comprising a urea-containing fertilizer (F1) and a urease inhibitor formulation (UI) comprising a mixture (A) comprising the at least one (thio)phosphoric acid triamide and a solvent (C) selected from the group consisting of a glycol ether, a glycerin ether, and mixtures thereof, wherein the inhibitor formulation (UI) is polymer free, and wherein the urease inhibitor formulation (UI) further comprises
(D) at least one amine selected from the group consisting of
(D2) an amine containing not more than one amino group and at least three alkoxy- or hydroxy-substituted C₂ to C₁₂ alkyl groups R²¹, wherein at least one of the groups R²¹ is different to the other groups R²¹,
(D3) an amine containing not more than one amino group and at least two alkoxy- or hydroxy-substituted C₂ to C₁₂ alkyl groups R²², wherein at least one of the groups R²² bears the alkoxy or hydroxy substituent at a secondary or tertiary carbon atom and wherein at least one of the groups R²² is different to the other group(s) R²²,
(D4) an amine containing at least one saturated or unsaturated C₈ to C₄₀ alkyl group R²³,
(D5) a saturated or unsaturated heterocyclic amine which contains at least one oxygen atom as ring atom and which does not contain a further alkoxy group, and
(D6) an amine selected from the group consisting of methyl-diethanolamine, methyl-diisopropanolamin, tetrahydroxy-propylethylenediamine, trimethylaminoethylethanolamine, N,N,N′,N′-tetramethyl-1,6-hexanediamine, N,N′,N″-tris(dimethylaminopropyl)hexahydrotriazine, and 2,2′-dimorpholinyldiethyl ether.

2. The method according to claim 1,
wherein the urease inhibitor formulation (UI) further comprises
(B) a polar aprotic solvent, wherein the polar aprotic solvent improves a cold stability of the urease inhibitor formulation (UI).

3. The method according to claim 1,
wherein the urease inhibitor formulation (UI) is coated onto the urea-containing fertilizer (F1).

4. The method according to claim 1,
wherein the solvent (C) is selected from the group consisting of diethylene glycol, dipropylene glycol, triethylene glycol, di-ethyleneglycol monobutylether, triethyleneglycol-n-butylether, and mixtures thereof, and/or
wherein the solvent (C) has a flashpoint (determined according to ISO 2719:2016) of more than 130° C.

5. The method according to claim 1,
wherein the mixture (A) comprises at least one (thio)phosphoric acid triamide according to general formula (I) 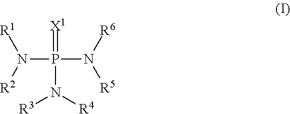
wherein
X¹ is O or S;
R¹ is C₁-C₂₀-alkyl, C₃-C₂₀-cycloalkyl, C₆-C₂₀-aryl, C₆-C₂₀-aryl-C₁-C₄-alkyl, or C₁-C₆-(di)alkylaminocarbonyl;
R² is H, C₁-C₂₀-alkyl, C₃-C₂₀-cycloalkyl, C₆-C₂₀-aryl, C₆-C₂₀-aryl-C₁-C₄-alkyl, or C₁-C₆-(di)alkylaminocarbonyl; or
R¹ and R² together with the nitrogen atom linking them define a 5- or 6-membered saturated or unsaturated heterocyclic radical, which optionally comprises 1 or 2 further heteroatoms selected from the group consisting of N, O, and S; and
R³, R⁴, R⁵, and R⁶ are independently of each other selected from the group consisting of H and C₁-C₄-alkyl;
wherein the at least one (thio)phosphoric acid triamide is comprised in the urease inhibitor formulation (UI) in an amount of 5 to less than 45 wt.-%, based on the total amount of the urease inhibitor formulation (UI).

6. The method according to claim 1,
wherein the at least one amine is selected from the group consisting of
(D2) an amine containing not more than one amino group and at least three hydroxy-substituted C₂ to C₈, wherein at least one of the groups R²¹ is different to the other groups R²¹,
(D3) an amine containing not more than one amino group and at least two alkoxy- or hydroxy-substituted C₂ to C₈, alkyl groups R²², wherein at least one of the groups R²² bears the alkoxy or hydroxy substituent at a secondary or tertiary carbon atom and wherein at least one of the groups R²² is different to the other group(s) R²²,
(D6) an amine selected from the group consisting of methyl-diethanolamine, methyl-diisopropanolamin, and N,N′,N″-tris(dimethylaminopropyl)hexahydrotriazine.

7. The according to claim 1,
wherein at least 85 wt.-% of the at least one (thio)phosphoric acid triamide in the urease inhibitor formulation (UI) is stable over a period of 14 days storage in closed bottles at 54° C.

8. The method according to claim 1,
wherein a pH of the urease inhibitor formulation (UI) is in the range of 8 to 10, and/or
wherein a pH change delta of the urease inhibitor formulation (UI) after two weeks storage at 54° C. is less than ±0.8, and/or
wherein the urease inhibitor formulation (UI) has a viscosity at a shear rate of 100 s⁻¹ determined according to CIPAC method 192 (rotational rheometer) of at most 100 mPas.

9. A urease inhibitor formulation (UI) having a viscosity at a shear rate of 100 s⁻¹ determined according to CIPAC method 192 (rotational rheometer) of at most 100 mPas at 10° C. comprising
(A) 10 to 45 wt.-% of a mixture (A) comprising N-(n-butyl)thiophosphoric acid triamide (NBPT) and N-(n-propyl)thiophosphoric acid triamide (NPPT),
(B) 0 to 50 wt.-% of N,N-dimethyl lactamide,
(C) 20 to 85 wt.-% of a solvent selected from the group consisting of a glycol ether, a glycerin ether, and mixtures thereof, and
(D) 3 to 25 wt.-% of at least one amine selected from the group consisting of
(D2) an amine containing not more than one amino group and at least three alkoxy- or hydroxy-substituted C₂ to C₁₂ alkyl groups R²¹, wherein at least one of the groups R²¹ is different to the other groups R²¹,
(D3) an amine containing not more than one amino group and at least two alkoxy- or hydroxy-substituted C₂ to C₁₂ alkyl groups R²², wherein at least one of the groups R²² bears the alkoxy or hydroxy substituent at a secondary or tertiary carbon atom and wherein at least one of the groups R²² is different to the other group(s) R²²,
(D4) an amine containing at least one saturated or unsaturated C₈ to C₄₀ alkyl group R²³,
(D5) a saturated or unsaturated heterocyclic amine which contains at least one oxygen atom as ring atom and which does not contain a further alkoxy group, and
(D6) an amine selected from the group consisting of methyl-diethanolamine, methyl-diisopropanolamin, tetrahydroxy-propylethylenediamine, trimethylaminoethylethanolamine, N,N,N′, N′-tetramethyl-1,6-hexanediamine, N,N′N″-tris(dimethylaminopropyl)hexahydrotriazine, and 2,2′-dimorpholinyldiethyl ether,
each based on the total amount of the urease inhibitor formulation (UI), wherein the inhibitor formulation (UI) is polymer free.

10. The urease inhibitor formulation (UI) according to claim 9,
wherein the solvent is selected from the group consisting of diethylene glycol, dipropylene glycol, triethylene glycol, di-ethyleneglycol monobutylether, triethyleneglycol-n-butylether, and mixtures thereof,
wherein the solvent has a flashpoint (determined according to ISO 2719:2016) of more than 130° C.

11. A fertilizer composition (1) comprising a urea-containing fertilizer (F1) and mixture (M) comprising
(A) a mixture (A) comprising at least one (thio)phosphoric acid triamide;
(B) N, N-dimethyl lactamide; and
(C) a solvent selected from the group consisting of a glycol ether, a glycerin ether, and mixtures thereof, wherein the mixture (M) is polymer free.

12. The fertilizer composition (1) according to claim 11,
wherein the mixture (A) comprises at least one (thio)phosphoric acid triamide according to general formula (I) 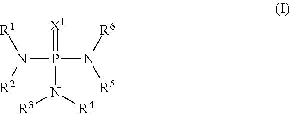
wherein
X¹ is O or S;
R¹ is C₁-C₂₀-alkyl, C₃-C₂₀-cycloalkyl, C₆-C₂₀-aryl, C₆-C₂₀-aryl-C₁-C₄-alkyl, or C₁-C₆-(di)alkylaminocarbonyl;
R² is H, C₁-C₂₀-alkyl, C₃-C₂₀-cycloalkyl, C₆-C₂₀-aryl, C₆-C₂₀-aryl-C₁-C₄-alkyl, or C₁-C₆-(di)alkylaminocarbonyl; or
R¹ and R² together with the nitrogen atom linking them define a 5- or 6-membered saturated or unsaturated heterocyclic radical, which optionally comprises 1 or 2 further heteroatoms selected from the group consisting of N, O, and S; and
R³, R⁴, R⁵, and R⁶ are independently of each other selected from the group consisting of H and C₁-C₄-alkyl; preferably
wherein the mixture (A) comprises N-(n-butyl)thiophosphoric acid triamide (NBPT) and/or N-(n-propyl)thiophosphoric acid triamide (NPPT).

13. The fertilizer composition (1) according to claim 11,
wherein the solvent is selected from the group consisting of diethylene glycol, dipropylene glycol, triethylene glycol, di-ethyleneglycol monobutylether, triethyleneglycol-n-butylether, and mixtures thereof,
wherein the solvent has a flashpoint (determined according to ISO 2719:2016) of more than 130° C.

14. The fertilizer composition (1) according to claim 11,
wherein the mixture (M) further comprises
(D) at least one amine selected from the group consisting of
(D2) an amine containing not more than one amino group and at least three alkoxy- or hydroxy-substituted C₂ to C₁₂ alkyl groups R²¹, wherein at least one of the groups R²¹ is different to the other groups R²¹,
(D3) an amine containing not more than one amino group and at least two alkoxy- or hydroxy-substituted C₂ to C₁₂ alkyl groups R²², wherein at least one of the groups R²² bears the alkoxy or hydroxy substituent at a secondary or tertiary carbon atom and wherein at least one of the groups R²² is different to the other group(s) R²²,
(D4) an amine containing at least one saturated or unsaturated C₈ to C₄₀ alkyl group R²³,
(D5) a saturated or unsaturated heterocyclic amine which contains at least one oxygen atom as ring atom and which does not contain a further alkoxy group, and
(D6) an amine selected from the group consisting of methyl-diethanolamine, methyl-diisopropanolamin, tetrahydroxy-propylethylenediamine, trimethylaminoethylethanolamine, N,N,N′,N′-tetramethyl-1,6-hexanediamine, N,N′N″-tris(dimethylaminopropyl)hexahydrotriazine, and 2,2′-dimorpholinyldiethyl ether.

15. The fertilizer composition (1) according to claim 11,
wherein the mixture (M) is coated onto the urea-containing fertilizer (F1).

16. The fertilizer composition (1) according to claim 11,
wherein the urea-containing fertilizer (F1) comprises at least one component selected from the group consisting of urea, urea ammonium nitrate (UAN), isobutylidene diurea (IBDU), crotonylidene diurea (CDU) and urea formaldehyde (UF), urea-acetaldehyde, and urea-glyoxal condensates.

17. The method according to claim 2 wherein the polar aprotic solvent (B) is a carboxylic acid amide.

18. The method according to claim 5 wherein the at least one thiophosphoric acid triamide comprises N-(n-butyl)thiophosphoric acid triamide (NBPT) and/or N-(n-propyl)thiophosphoric acid triamide (NPPT).

19. The method according to claim 6 wherein the at least one amine D6 is selected from the group consisting of methyl-diethanolamine (MDEOA), methyl-diisopropanolamin (MDIPOA), methyl-ethanol-isopropanolamin (MEIPOA), N,N′,N″-tris(dimethylaminopropyl)hexahydrotriazine (NNN), 1,1′-((2-Hydroxyethyl)imino)dipropan-2-ol (EDIPOA), and bis(hydroxyethyl)-isopropanolamine (DEIPA).
